(19) United States
(12) Patent Application Publication
(10) Pub. No.: US 2024/0278618 A1
(43) Pub. Date: Aug. 22, 2024

(54) LINK MECHANISM

(71) Applicant: DENSO CORPORATION, Kariya-City (JP)

(72) Inventor: Shunya INUKAI, Kariya-City (JP)

(21) Appl. No.: 18/652,172

(22) Filed: May 1, 2024

Related U.S. Application Data
(63) Continuation of application No. PCT/JP2022/038520, filed on Oct. 17, 2022.

(30) Foreign Application Priority Data
Nov. 5, 2021 (JP) 2021-180954

(51) Int. Cl. B60H 1/00

(52) U.S. Cl. CPC B60H 1/00692; B60H 1/00857

(57) ABSTRACT

A link mechanism includes a drive device, a driven member, a first drive force transmission mechanism, a second drive force transmission mechanism and a transmission path switch device. The drive device generates a drive force. The driven member is moved by the drive force. The first drive force transmission mechanism transmits the drive force toward the driven member at a speed reduction ratio which is predetermined. The second drive force transmission mechanism transmits the drive force toward the driven member at a speed reduction ratio which is different from the speed reduction ratio of the first drive force transmission mechanism. The transmission path switch device switches a transmission path, along which the drive force is transmitted from the drive device toward the driven member, to one of the first drive force transmission mechanism and the second drive force transmission mechanism.

### CROSS REFERENCE TO RELATED APPLICATIONS

This application is a continuation application of International Patent Application No. PCT/JP2022/038520 filed on Oct. 17, 2022, which designated the U.S. and claims the benefit of priority from Japanese Patent Application No. 2021-180954 filed on Nov. 5, 2021. The entire disclosures of all of the above applications are incorporated herein by reference.

### TECHNICAL FIELD

The present disclosure relates to a link mechanism that is configured to transmit a drive force, which is generated by a drive device, to a driven member.

### BACKGROUND

Previously, in a vehicle air conditioning apparatus, a door (serving as a driven member) is moved by transmitting a drive force, which is generated by a drive device (e.g., a servomotor), to the door to adjust an opening degree of an air passage. There has been proposed a link mechanism used in such a vehicle air conditioning apparatus.

The previously proposed link mechanism is applied to the vehicle air conditioning apparatus, and thereby a plurality of doors of the vehicle air conditioning apparatus are driven by a single servomotor (i.e., only one servomotor). In this way, the number of servomotors can be reduced, and thereby the costs of the vehicle air conditioning apparatus can be reduced.

### SUMMARY

This section provides a general summary of the disclosure, and is not a comprehensive disclosure of its full scope or all of its features.

According to the present disclosure, there is provided a link mechanism that includes a drive device, a driven member, a first drive force transmission mechanism, a second drive force transmission mechanism and a transmission path switch device. The drive device is configured to generate a drive force. The driven member is configured to be moved by an action of the drive force generated by the drive device. The first drive force transmission mechanism is configured to transmit the drive force, which is generated by the drive device, to the driven member at a speed reduction ratio which is predetermined. The second drive force transmission mechanism is configured to transmit the drive force, which is generated by the drive device, to the driven member at a speed reduction ratio which is different from the speed reduction ratio of the first drive force transmission mechanism. The transmission path switch device is configured to switch a transmission path, along which the drive force is transmitted from the drive device toward the driven member, to one of the first drive force transmission mechanism and the second drive force transmission mechanism.

### BRIEF DESCRIPTION OF DRAWINGS

The drawings described herein are for illustrative purposes only of selected embodiments and not all possible implementations, and are not intended to limit the scope of the present disclosure.

FIG. 1 is a cross-sectional view of a vehicle air conditioning apparatus that includes a link mechanism according to a first embodiment.

FIG. 2 is an explanatory diagram showing a normal drive mode of the link mechanism of the first embodiment.

FIG. 3 is an explanatory diagram showing a high precision drive mode of the link mechanism of the first embodiment.

FIG. 4 is a top view of the link mechanism of the first embodiment when the link mechanism is in a face mode.

FIG. 5 is an explanatory diagram showing mechanism components in a case where the link mechanism of the first embodiment is in the face mode.

FIG. 6 is a cross-sectional view taken along line VI-VI in FIG. 4.

FIG. 7 is an explanatory diagram showing the mechanism components in a case where the link mechanism of the first embodiment is in a foot mode.

FIG. 8 is an explanatory diagram showing arrangement of link grooves and link pins in the case where the link mechanism of the first embodiment is in the foot mode.

FIG. 9 is an explanatory diagram showing arrangement of the mechanism components in a case where the link mechanism of the first embodiment is in a defroster mode.

FIG. 10 is an explanatory diagram showing arrangement of the link grooves and the link pins in the case where the link mechanism of the first embodiment is in the defroster mode.

FIG. 11 is an explanatory diagram showing a relationship among drive modes and blowout modes of the link mechanism of the first embodiment.

FIG. 12 is an explanatory diagram showing a first state at a mode shift time of the link mechanism of the first embodiment.

FIG. 13 is an explanatory diagram showing a second state at the mode shift time of the link mechanism of the first embodiment.

FIG. 14 is an explanatory diagram showing a third state at the mode shift time of the link mechanism of the first embodiment.

FIG. 15 is an explanatory diagram showing a fourth state at the mode shift time of the link mechanism of the first embodiment.

FIG. 16 is a schematic diagram showing a structure of a link mechanism of a second embodiment.

FIG. 17 is a schematic diagram showing a structure of a link mechanism of a third embodiment.

FIG. 18 is a schematic diagram showing a structure of a link mechanism of a fourth embodiment.

FIG. 19 is a schematic diagram showing a structure of a link mechanism of a fifth embodiment.

FIG. 20 is a top view of the link mechanism of the fifth embodiment when the link mechanism is in the face mode.

FIG. 21 is an explanatory diagram showing mechanism components in a case where the link mechanism of the fifth embodiment is in the face mode.

FIG. 22 is a cross-sectional view taken along line XXII-XXII n FIG. 20.

FIG. 23 is an explanatory diagram showing the mechanism components in a case where the link mechanism of the fifth embodiment is in the foot mode.

FIG. 24 is an explanatory diagram showing arrangement of link grooves and link pins in a case where the link mechanism of the fifth embodiment is in the foot mode.

FIG. 25 is an explanatory diagram showing arrangement of the mechanism components in a case where the link mechanism of the fifth embodiment is in the defroster mode.

FIG. 26 is an explanatory diagram showing arrangement of link grooves and link pins in a case where the link mechanism of the fifth embodiment is in the defroster mode.

FIG. 27 is a schematic diagram showing a structure of a link mechanism of a sixth embodiment.

### DETAILED DESCRIPTION

Previously, in a vehicle air conditioning apparatus, a door (serving as a driven member) is moved by transmitting a drive force, which is generated by a drive device (e.g., a servomotor), to the door to adjust an opening degree of an air passage. There has been proposed a link mechanism used in such a vehicle air conditioning apparatus.

The previously proposed link mechanism is applied to the vehicle air conditioning apparatus, and thereby a plurality of doors of the vehicle air conditioning apparatus are driven by a single servomotor (i.e., only one servomotor). In this way, the number of servomotors can be reduced, and thereby the costs of the vehicle air conditioning apparatus can be reduced.

Here, the plurality of doors are moved by the drive force of the single drive device. Therefore, a transmission mechanism for transmitting the drive force becomes complicated, and thereby an influence of tolerances of components of the transmission mechanism is increased to possibly cause a deterioration in the precision with respect to the movement of the driven member. Since the movement of the driven member is executed in the low precision state, there may be a case where the movement of the driven member may not be appropriate for some cases. Furthermore, since the number of the components of the transmission mechanism is increased, it is difficult to meet the demand for downsizing the vehicle air conditioning apparatus.

According to one aspect of the present disclosure, there is provided a link mechanism that includes a drive device, a driven member, a first drive force transmission mechanism, a second drive force transmission mechanism and a transmission path switch device. The drive device is configured to generate a drive force. The driven member is configured to be moved by an action of the drive force generated by the drive device. The first drive force transmission mechanism is configured to transmit the drive force, which is generated by the drive device, to the driven member at a speed reduction ratio which is predetermined. The second drive force transmission mechanism is configured to transmit the drive force, which is generated by the drive device, to the driven member at a speed reduction ratio which is different from the speed reduction ratio of the first drive force transmission mechanism. The transmission path switch device is configured to switch a transmission path, along which the drive force is transmitted from the drive device toward the driven member, to one of the first drive force transmission mechanism and the second drive force transmission mechanism.

According to the link mechanism described above, the transmission path switch device can switch the transmission path, which transmits the drive force from the drive device toward the driven member, to one of the transmission path through the first drive force transmission mechanism and the transmission path through the second drive force transmission mechanism. The first drive force transmission mechanism and the second drive force transmission mechanism are configured to transmit the drive force to the driven member at the different speed reduction ratios, respectively. Therefore, the link mechanism can realize the two different modes as the moving modes (e.g., the modes for implementing the two different amounts of movement) of the driven member realized by the action of the drive force. As a result, the link mechanism can move the driven member by the appropriate amount of movement according to the scene by using the two different moving modes.

Hereinafter, embodiments of the present disclosure will be described with reference to the drawings. In each of the following embodiments, the same reference signs may be assigned to portions that are the same as or equivalent to those described in the preceding embodiment(s), and the description thereof may be omitted. Further, when only a portion of any one of the components is described in the embodiment, the description of the rest of the components described in the preceding embodiment may be applied to the rest of the components. In addition to the combinations of portions that are specifically shown to be combinable in the respective embodiments, it is also possible to partially combine the embodiments even if they are not specifically shown, provided that the combinations are not impeded.

### First Embodiment

A first embodiment of the present disclosure will be described with reference to the drawings. In the first embodiment, a link mechanism 1 of the present disclosure is used as a mechanism that moves a plurality of doors (including a face door 50) of a vehicle air conditioning apparatus 100.

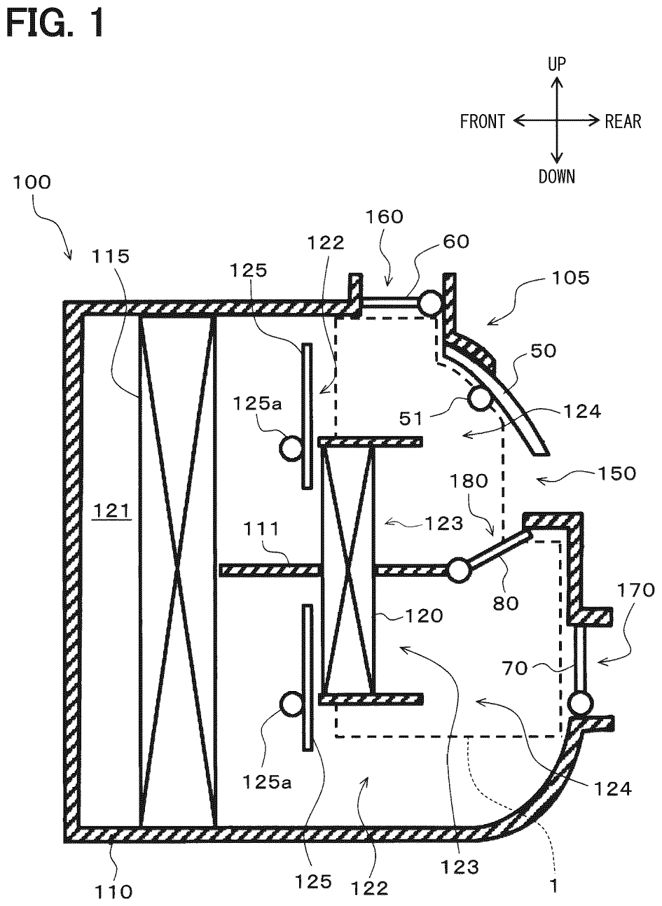

First of all, a structure of the vehicle air conditioning apparatus 100, to which the link mechanism 1 is applied, will be described with reference to the drawings. FIG. 1 is a cross-sectional view of the vehicle air conditioning apparatus 100 of the first embodiment. Arrows, which face an up-side (up) and a down-side (down), respectively, in FIG. 1, indicate an up-to-down direction in an installed state where the vehicle air conditioning apparatus 100 is installed on the vehicle. Arrows, which face a front side (front) and a rear side (rear), respectively, in FIG. 1, indicate a front-to-rear direction in the installed state. Furthermore, a front side and a back side of a plane of FIG. 1 indicate a left-to-right direction of the vehicle air conditioning apparatus 100 in the installed state.

The vehicle air conditioning apparatus 100 of the first embodiment is placed at a location that is on a lower side of an instrument panel in a cabin (serving as an air conditioning subject space) of the vehicle to air condition the cabin. The vehicle air conditioning apparatus 100 includes a cabin air conditioning unit 105 that is configured to supply conditioning air, the temperature of which is adjusted by a refrigeration cycle.

The cabin air conditioning unit 105 cooperates with a blower unit to form a ventilation system of the vehicle air conditioning apparatus 100 and is placed generally at a center in the left-to-right direction of the vehicle at the location that is on the lower side of the instrument panel in the cabin. The blower unit is offset from the center toward a front passenger seat side at the location which is on the lower side of the instrument panel in the cabin. The blower unit includes an inside/outside air switching box and a blower. The blower is configured to suction the air through the inside/outside air switching box and discharges the suctioned air.

The inside/outside air switching box has: an outside air inlet, which introduces the outside air (i.e., the air outside the cabin); and an inside air inlet, which introduces the inside air (i.e., the air inside the cabin). The outside air inlet and the inside air inlet are opened and closed by an inside/outside air switching door which is driven by an electric actuator.

Furthermore, the blower of the blower unit includes a centrifugal fan, a drive electric motor (or simply referred to as a drive motor) and a scroll case. More specifically, the blower includes two sets of centrifugal fans and two sets of scroll cases. The blower unit can switch its operation mode among: an outside air mode for blowing only the outside air; an inside air mode for blowing only the inside air; and an inside/outside air two-layer mode for blowing the outside air and the inside air.

In the vehicle air conditioning apparatus 100, an evaporator 115 (i.e., a cooling heat exchanger) and a heater core 120 (i.e., a heating heat exchanger) are received in a common air conditioning case 110. The air conditioning case 110 is a molded article made of a resin material (e.g., polypropylene) which has a certain degree of resiliency and high strength.

Specifically, the air conditioning case 110 includes a plurality of separate cases which are formed separately. These separate cases are joined together by fasteners (e.g., metal spring clips and/or screws) after receiving the evaporator 115 and the heater core 120 at the inside of the separate cases. Thereby, the separate cases form a part of the cabin air conditioning unit 105 of the vehicle air conditioning apparatus 100.

Two air inlets (not shown) are formed at sides of a front end portion of the air conditioning case 110 that is closest to the vehicle font side. These air inlets correspond to the two scroll cases, respectively, of the blower unit. Specifically, at the time of the outside air mode, the outside air flows into the two air inlets. At the time of the inside air mode, the inside air flows into the two air inlets. At the time of the inside/outside air two-layer mode, the outside air flows into one of the two air inlets from one of the scroll cases, and the inside air flows into the other one of the two air inlets from the other one of the two scroll cases.

As shown in FIG. 1, a partition plate 111 extends through the entire extent of the inside of the air conditioning case 110 in the left-to-right direction of the vehicle. The partition plate 111 is molded integrally with the air conditioning case 110 and partitions an air passage 121 of the air conditioning case 110 into two air passages (upper and lower air passages) in the up-to-down direction of the vehicle.

The upper air passage, which is located on the upper side of the partition plate 111, conducts the air, which flows from the one of the two air inlets. The lower air passage, which is located on the lower side of the partition plate 111, conducts the air, which flows from the other one of the two air inlets. In the case of the inside/outside air two-layer mode, the outside air is conducted through the upper side air passage located on the upper side of the partition plate 111, and the inside air is conducted through the lower air passage located on the lower side of the partition plate 111.

The evaporator 115 is placed at a location immediately after the air inlets in the flow direction of the air in the inside of the air conditioning case 110. The evaporator 115 extends generally in parallel with the up-to-down direction of the vehicle through the entire extent of the inside of the air conditioning case 110 in the up-to-down direction of the vehicle. Although not depicted in the drawing, a width dimension of the evaporator 115 in the left-to-right direction of the vehicle is substantially the same as a width dimension of the air conditioning case 110 in the left-to-right direction.

The evaporator 115 is the cooling heat exchanger that absorbs heat from the conditioning air (i.e., the air for conditioning the cabin) as latent heat of evaporation of a refrigerant in the refrigeration cycle of the vehicle air conditioning apparatus 100 and thereby cools the conditioning air. The evaporator 115 is arranged to extend through a through-hole formed through the partition plate 111.

Therefore, an upper portion of the evaporator 115 is placed in the upper air passage located on the upper side of the partition plate 111, and a lower portion of the evaporator 115 is placed in the lower air passage located on the lower side of the partition plate 111. Therefore, the upper portion of the evaporator 115 can cool the air, which flows in the upper air passage located on the upper side of the partition plate 111, and the lower portion of the evaporator 115 can cool the air, which flows in the lower air passage located on the lower side of the partition plate 111.

The heater core 120 is placed on the downstream side (i.e., the vehicle rear side) of the evaporator 115 in the flow direction of the air and is spaced from the evaporator 115 by a predetermined distance. Although not depicted in the drawing, a width dimension of the heater core 120 in the left-to-right direction of the vehicle is substantially the same as the width dimension of the air conditioning case 110 in the left-to-right direction.

The heater core 120 is the heating heat exchanger that heats the blown air which has passed through the evaporator 115 and is thereby cooled. The heater core 120 includes: a plurality of tubes (e.g., flat tubes), through which a heat medium having a high temperature (e.g., a heat medium in a high-temperature side heat medium circuit, or an engine coolant) flows; and a plurality of corrugated fins, which are joined to the tubes.

As shown in FIG. 1, the heater core 120 is arranged to extend through a through-hole formed through the partition plate 111. Therefore, an upper portion of the heater core 120 is placed in the upper air passage located on the upper side of the partition plate 111, and a lower portion of the heater core 120 is placed in the lower air passage located on the lower side of the partition plate 111. Thus, the upper portion of the heater core 120 can heat the air, which flows in the upper air passage located on the upper side of the partition plate 111, and the lower portion of the heater core 120 can heat the air, which flows in the lower air passage located on the lower side of the partition plate 111.

A low-temperature air bypass passage 122 is formed on the upper side of the heater core 120 in the upper air passage located on the upper side of the partition plate 111. The low-temperature air bypass passage 122 is a passage through which the air cooled by the upper portion of the evaporator 115 flows while bypassing the heater core 120. Since the low-temperature air bypass passage 122 bypasses the heater core 120, the air, which has passed through the upper portion of the evaporator 115, remains cold and flows to the downstream side.

Another low-temperature air bypass passage 122 is formed on the lower side of the heater core 120 in the lower air passage located on the lower side of the partition plate 111. On the lower side of the partition plate 111, the low-temperature air bypass passage 122 is a passage through which the air cooled by the lower portion of the evaporator 115 flows while bypassing the heater core 120. Since this low-temperature air bypass passage 122 bypasses the heater core 120, the air, which has passed through the lower portion of the evaporator 115, remains cold and flows to the downstream side.

At an upper portion of the air conditioning case 110, an air mix door 125 is placed between the evaporator 115 and the heater core 120. The air mix door 125 is a sliding door that is configured to be slid generally in parallel to a front surface of the heater core 120. Although not depicted in the drawing, the air mix door 125 includes: a door main body, which is shaped in a plate form; and two racks which are formed integrally with the door main body.

Two opposite end portions (i.e., two end portions which are opposite to each other in the direction perpendicular to the plane of FIG. 1) of the door main body of the air mix door 125 are inserted in two guide grooves, respectively, which are respectively formed at the sides of the air conditioning case 110. The guide grooves are respectively formed by two opposed walls which inwardly project from the sides of the air conditioning case 110. The guide grooves extend generally in parallel with an air inlet surface of the heater core 120 generally in the up-to-down direction. The guide grooves have a function of guiding an operating direction (i.e., a sliding direction) of the air mix door 125 generally in parallel with the air inlet surface of the heater core 120 generally in the up-to-down direction.

The racks of the air mix door 125 are respectively meshed with two pinions which are formed at a shaft 125a. The shaft 125a extends in the left-to-right direction of the vehicle (the direction perpendicular to the plane of FIG. 1) and is rotatably supported by the sides of the air conditioning case 110. One end portion of the shaft 125a extends through a side wall of the air conditioning case 110 and is coupled with an electric actuator (not shown).

Therefore, when the shaft 125a is rotated by the electric actuator, a rotational motion of the shaft 125a is converted into a slide motion of the air mix door 125. Thereby, a slide position of the air mix door 125 on the upper side of the partition plate 111 is adjusted.

On the upper side of the partition plate 111, a high-temperature air passage 123 is formed on the downstream side (the vehicle rear side) of the heater core 120 in the flow direction of the blown air. The high-temperature air passage 123 is an air passage that conducts the high-temperature air which is heated by the heater core 120. Furthermore, on the upper side of the partition plate 111, an air mixing portion 124 is formed on the downstream side of the low-temperature air bypass passage 122 and the high-temperature air passage 123 in the flow direction of the air. The high-temperature air, which is conducted in the high-temperature air passage 123, and the low-temperature air, which is conducted in the low-temperature air bypass passage 122, are mixed in the air mixing portion 124.

As described above, by adjusting the slide position of the air mix door 125, the air mix door 125 can adjust an air flow rate ratio between a flow rate of the high-temperature air, which is heated by the upper portion of the heater core 120, and a flow rate of the low-temperature air, which is conducted through the low-temperature air bypass passage 122 while bypassing the upper portion of the heater core 120. The high-temperature air, which is discharged from the upper portion of the heater core 120, and the low-temperature air, which is conducted in the low-temperature air bypass passage 122, merge with each other in the air mixing portion 124 located on the upper side of the partition plate 111, and thereby, the air, which has a desired temperature, can be formed at the air mixing portion 124.

Here, as shown in FIG. 1, another air mix door 125 is placed between the evaporator 115 and the heater core 120 on the lower side of the partition plate 111. The air mix door 125 on the lower side of the partition plate 111 is also a slide door that is configured to be slid in a predetermined direction on the front side of the heater core 120, and this air mix door 125 includes: a door main body, which is shaped in a plate form; and two racks which are formed integrally with the door main body. Specifically, the air mix door 125 on the lower side of the partition plate 111 is slidably formed with the structure, which is the same as that of the air mix door 125 on the upper side of the partition plate 111.

On the lower side of the partition plate 111, another high-temperature air passage 123 is formed on the downstream side of the heater core 120 in the flow direction of the blown air. The high-temperature air passage 123 is an air passage that conducts the high-temperature air which is heated by the heater core 120. Furthermore, on the lower side of the partition plate 111, another air mixing portion 124 is formed on the downstream side of the low-temperature air bypass passage 122 and the high-temperature air passage 123 in the flow direction of the blown air. The high-temperature air, which is conducted in the high-temperature air passage 123, and the low-temperature air, which is conducted in the low-temperature air bypass passage 122, are mixed in the air mixing portion 124.

Thus, even on the lower side of the partition plate 111, by adjusting the slide position of the air mix door 125, the air mix door 125 can adjust an air flow rate ratio between a flow rate of the high-temperature air, which is heated by the lower portion of the heater core 120, and a flow rate of the low-temperature air, which is conducted through the low-temperature air bypass passage 122 while bypassing the lower portion of the heater core 120. The high-temperature air, which is discharged from the lower portion of the heater core 120, and the low-temperature air, which is conducted in the low-temperature air bypass passage 122, merge with each other in the air mixing portion 124 located on the lower side of the partition plate 111, and thereby, the air, which has a desired temperature, can be formed at the air mixing portion 124.

Furthermore, as shown in FIG. 1, a defroster opening 160 is formed at a location adjacent to the upper air mixing portion 124 at the air conditioning case 110. The defroster opening 160 is connected to defroster outlets through a defroster duct (not shown), and the conditioning air, which is appropriately adjusted, flows from the air mixing portion 124 into the defroster opening 160. The conditioning air, which is outputted from the defroster opening 160, is discharged against an inner surface of the vehicle front window glass through the defroster outlets.

A defroster door 60 is placed at the defroster opening 160. The defroster door 60 can be moved by a drive force transmitted from a drive motor (a single drive electric motor) 5 to adjust an opening cross-sectional area of the defroster opening 160. The link mechanism 1 of the present disclosure is used for the transmission of the drive force to the defroster door 60.

A face opening 150 opens at an upper portion of the air conditioning case 110 at a location which is on the vehicle rear side of the defroster opening 160. The face outlet is connected to face outlets placed on the upper side of the instrument panel through a face duct, and the conditioning air, which is appropriately adjusted, flows from the air mixing portion 124 into the face opening 150. The conditioning air, which is outputted from the face opening 150, is discharged toward a head of an occupant(s) seated on a front seat(s) in the cabin through the face outlets.

A face door 50, which is formed as a slide door, is installed to the face opening 150. The face door 50 includes: a door main body, which is shaped in a plate form; and two racks which are formed integrally with the door main body. The face door 50 is installed such that the face door 50 is slid along two guide grooves formed along an opening edge of the face opening 150. The face door 50 can reciprocate at the opening edge of the face opening 150 along a moving path defined by the guide grooves.

The racks of the face door 50 are respectively meshed with two pinions which are formed at a door shaft 51, thereby forming a rack and pinion. The door shaft 51 extends in the left-to-right direction of the vehicle and is rotatably supported by the sides of the air conditioning case 110. One end portion of the door shaft 51 extends through a shaft hole 110a formed through the side wall of the air conditioning case 110 and is placed at the outside of the air conditioning case 110.

The link mechanism 1, which is indicated by a dotted line in FIG. 1, is placed at the outside of the air conditioning case 110. The link mechanism 1 is configured to transmit the drive force of the drive motor 5 of the link mechanism 1 to the door shaft 51. A specific structure of the link mechanism 1 will be described later in detail.

Thus, when the drive force is transmitted to the door shaft 51 through the link mechanism 1, the rotational motion of the door shaft 51 is converted into the slide motion of the face door 50 to adjust the slide position of the face door 50 at any position along the guide grooves. The face door 50 is an example of a driven member of the present disclosure. Furthermore, the face door 50 can be urged against a seal surface formed at the air conditioning case 110 by a pressure of the air flow to seal the passage.

Furthermore, two foot openings 170 are opened at a rear portion of the air conditioning case 110 located on the vehicle rear side such that the foot openings 170 are placed adjacent to the air mixing portion 124 on the lower side of the partition plate 111. Each of the foot openings 170 is an opening into which the conditioning air from the air mixing portion 124 on the lower side of the partition plate 111 flows after the adjustment of the conditioning air at the air mixing portion 124, and the foot openings 170 open at the left side and the right side, respectively, of the air conditioning case 110. The foot openings 170 can discharge the conditioning air to the feet of the occupant(s) on the front seat(s) through foot outlets which are provided for the front seat(s) and are arranged at the left side and the right side.

Two foot doors 70 are placed at opening edges, respectively, of the foot openings 170 at the inside of the air conditioning case 110. The foot doors 70 are rotatably supported by a rotatable shaft, which extends in the left-to-right direction of the vehicle, and the foot doors 70 are coupled to the link mechanism 1 described later. Thus, when each of the foot doors 70 is rotated by the drive force transmitted through the link mechanism 1, the foot door 70 opens or closes the corresponding foot opening 170.

Here, as shown in FIG. 1, the partition plate 111 extends to a rear wall surface of the air conditioning case 110 placed on the vehicle rear side and has a function of partitioning between the air mixing portion 124 placed on the upper side of the partition plate 111 and the air mixing portion 124 placed on the lower side of the partition plate 111. A communication opening 180 is formed at a rear end portion of the partition plate 111, which is placed on the vehicle rear side, to communicate between the air mixing portion 124 placed on the upper side of the partition plate 111 and the air mixing portion 124 placed on the lower side of the partition plate 111.

A communication opening door 80 is placed at an opening edge of the communication opening 180. The communication opening door 80 is rotatably supported by a rotatable shaft, which extends in the left-to-right direction of the vehicle, and the communication opening door 80 is coupled to the link mechanism 1 described later. Thus, when the communication opening door 80 is rotated by the drive force transmitted through the link mechanism 1, the communication opening door 80 opens and closes the communication opening 180.

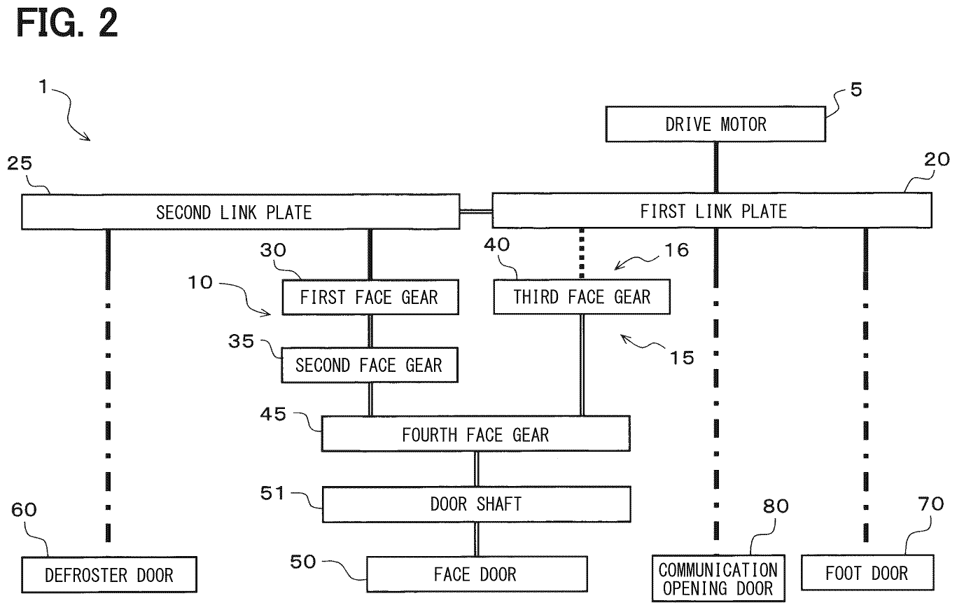

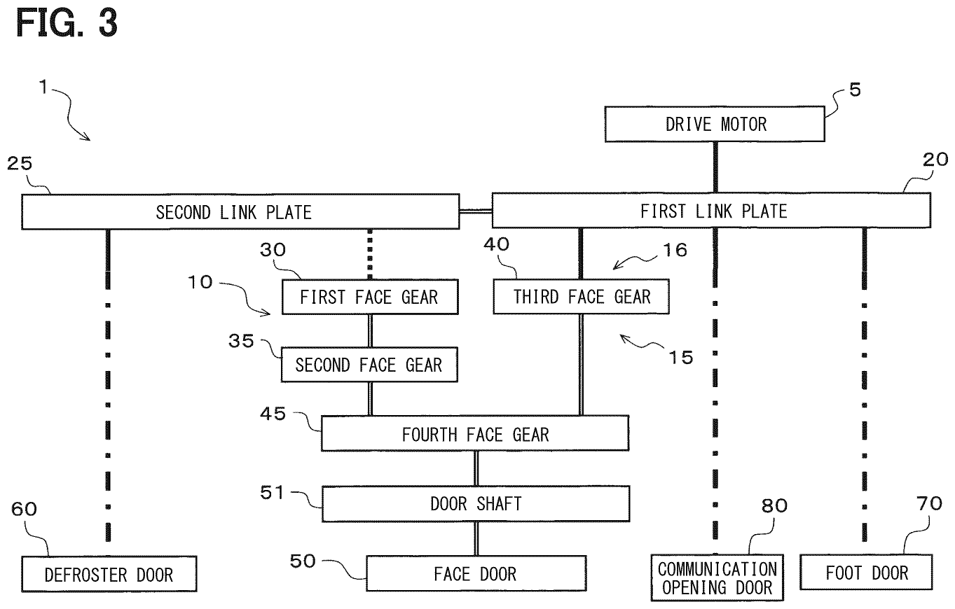

Next, a structure of the link mechanism 1 of the first embodiment will be described with reference to FIGS. 2 to 5. FIGS. 2 and 3 are schematic diagrams showing the structure of the link mechanism 1 of the first embodiment. In FIGS. 2 and 3, transmission states of the drive force are indicated by different types of lines, each of which is drawn between corresponding two of a plurality of mechanism components 16 of the link mechanism 1. At the structure where the drive force is transmitted through use of a corresponding link pin and a corresponding link groove, a state, in which the link pin and the link groove are in contact with each other, is indicated by a solid line, and another state, in which the link pin and the link groove are not in contact with each other, is indicated by a dotted line. Furthermore, a state, in which the gear portions of the mechanism components 16 are meshed with each other to transmit the drive force, is indicated by a double line.

The link mechanism 1 of the first embodiment is placed at the outer wall surface of the air conditioning case 110 at the vehicle air conditioning apparatus 100 and is configured to transmit the drive force generated by the drive motor 5 to the doors including the face door 50. Specifically, the link mechanism 1 is configured to distribute and transmit the drive force generated by the drive motor 5 to four types of driven members, such as the face door 50, the defroster door 60, the foot doors 70 (hereinafter only one of the foot doors 70 will be described for the sake of simplicity), and the communication opening door 80.

The vehicle air conditioning apparatus 100 controls these four types of doors through the link mechanism 1 to implement a plurality of different types of blowout modes. These blowout modes include a face mode, a bilevel mode, a foot mode, a defroster mode and a foot/defroster mode.

The face mode is a discharge outlet mode for discharging the air toward an upper body of the occupant in the cabin from the face outlets by fully opening the face opening 150. The bilevel mode is a discharge outlet mode for discharging the air toward the upper body and the feet of the occupant in the cabin by opening the face opening 150 and the foot opening 170. The foot mode is a discharge outlet mode for discharging the air mainly from the foot outlets by fully opening the foot opening 170 and opening the defroster opening 160 at a small opening degree.

The defroster mode is a discharge outlet mode for discharging the air toward the inner surface of the front window glass by fully opening the defroster opening 160. The foot/defroster mode is a discharge outlet mode for discharging the air from the foot outlets and the defroster outlets by opening the foot opening 170 and the defroster opening 160 at generally the equal opening degree.

As shown in FIGS. 2 and 3, the link mechanism 1 of the first embodiment includes the mechanism components 16 for transmitting the drive force from the drive motor (serving as a drive power source) 5. The drive motor 5 is a servomotor and generates the drive force based on a control signal received from a control device (the control device including at least one processor and at least one memory to execute a control program) of the vehicle air conditioning apparatus 100.

The mechanism components 16 include a first link plate 20 and a second link plate 25. The first link plate 20 is installed to a first plate support shaft 20a formed at the outside of the air conditioning case 110 and is rotated by the drive force generated by the drive motor 5.

As shown in FIGS. 2 and 3, a portion of the drive force generated by the drive motor 5 is transmitted to the foot door 70 and the communication opening door 80 through the first link plate 20. Thus, in the vehicle air conditioning apparatus 100, the opening and closing operation of each of the foot door 70 and the communication opening door 80 is performed through the link mechanism 1.

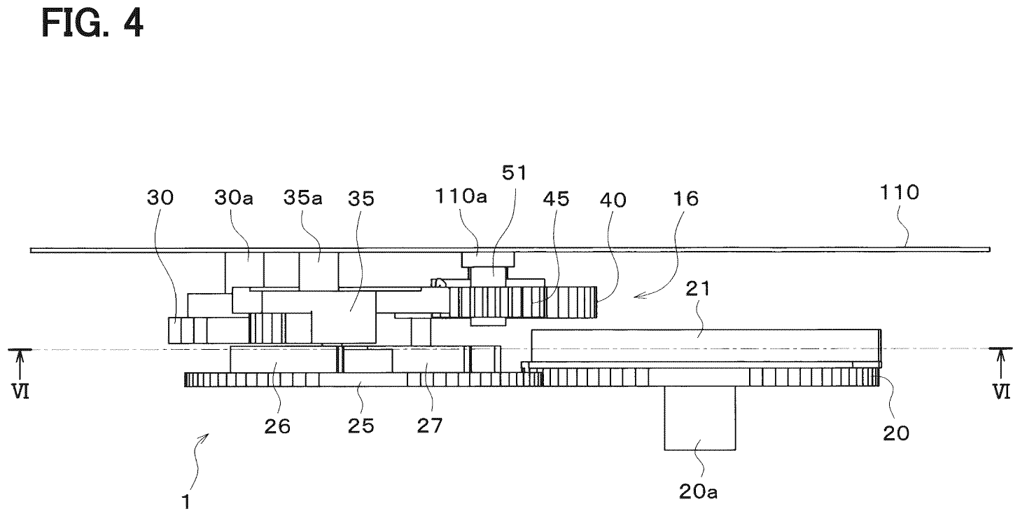

As shown in FIGS. 4 to 6, the first link plate 20 has a first link groove 21 which forms a part of the transmission path switch device 90 and is formed at a surface of the first link plate 20 that is opposed to the outer surface of the air conditioning case 110. The first link groove 21 is in a form of a groove that extends along a semicircle centered on the first plate support shaft 20a, and two opposite end portions of the first link groove 21 are both opened. The first link groove 21 is formed such that a link pin 42 of a third face gear 40 described later can be inserted into the first link groove 21. The drive force, which is transmitted to the first link plate 20, can be transmitted to the third face gear 40 through contact of the link pin 42 to the first link groove 21 at the inside of the first link groove 21.

The second link plate 25 is rotatably supported by a second plate support shaft 25a formed at the air conditioning case 110, and the second link plate 25 is installed such that a gear portion (i.e., a portion having a plurality of gear teeth) of the second link plate 25 is meshed with a gear portion of the first link plate 20. Thus, when the drive force is inputted to the first link plate 20, the drive force is transmitted to the second link plate 25 through the gear portion of the first link plate 20 and the gear portion of the second link plate 25, and thereby, the second link plate 25 is rotated about the second plate support shaft 25a.

As shown in FIGS. 2 and 3, a portion of the drive force, which is transmitted from the first link plate 20, is transmitted to the defroster door 60 through the second link plate 25. Thus, in the vehicle air conditioning apparatus 100, the opening and closing operation of the defroster door 60 is performed through the link mechanism 1.

As shown in FIGS. 4 to 6, the second link plate 25 has a second link groove 26 and a third link groove 27 which form a part of the transmission path switch device 90 and are formed at a surface of the second link plate 25 that is opposed to the outer surface of the air conditioning case 110. The second link groove 26 is in a form of a groove that extends along a semicircle centered on the second plate support shaft 25a, and one of two opposite end portions of the second link groove 26 is opened, and the other one of the two opposite end portions of the second link groove 26 is closed. Like the second link groove 26, the third link groove 27 is in a form of a groove that extends along a semicircle centered on the second plate support shaft 25a, and one of two opposite end portions of the third link groove 27 is opened, and the other one of the opposite end portions of the third link groove 27 is closed.

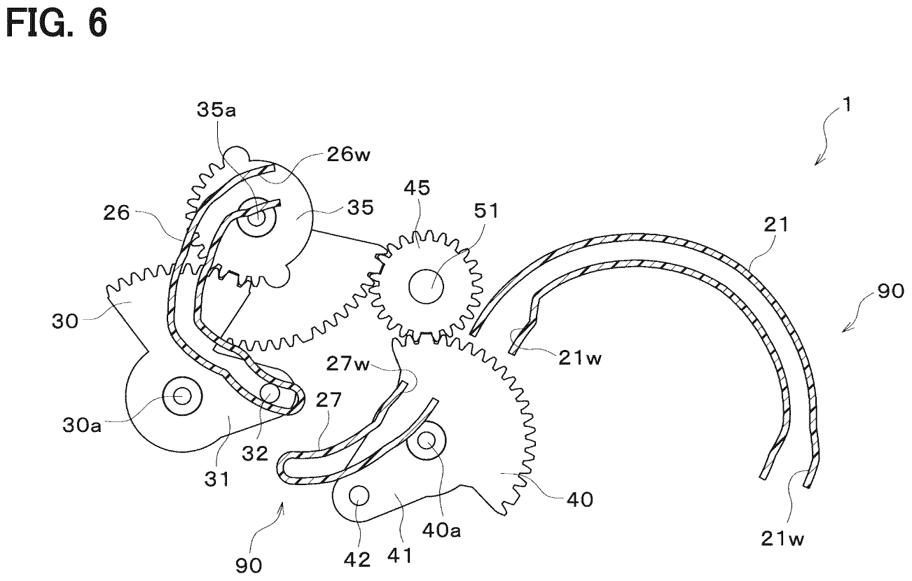

Each of the second link groove 26 and the third link groove 27 is formed such that a link pin 32 of a first face gear 30 described later can be inserted into each of the second link groove 26 and the third link groove 27. The drive force, which is transmitted to the second link plate 25, can be transmitted to the first face gear 30 through contact of the link pin 32 to the second link groove 26 at the inside of the second link groove 26. Also, the drive force, which is transmitted to the second link plate 25, can be transmitted to the first face gear 30 through contact of the link pin 32 to the third link groove 27 at the inside of the third link groove 27. As shown in FIG. 6, the open end portion of the second link groove 26 and the open end portion of the third link groove 27 are spaced from each other by a distance and are opposed to each other. Therefore, the link pin 32, which is moved from the inside to the outside of one of the second link groove 26 and the third link groove 27, is moved a predetermined distance and is then moved into the inside of the other one of the second link groove 26 and the third link groove 27.

Furthermore, the link mechanism 1 of the first embodiment includes a first drive force transmission mechanism 10 and a second drive force transmission mechanism 15 for transmitting the drive force of the drive motor 5 to the face door 50 to drive the face door 50. Each of the first drive force transmission mechanism 10 and the second drive force transmission mechanism 15 includes the corresponding mechanism components 16 for transmitting the drive force.

Specifically, the first drive force transmission mechanism 10 and the second drive force transmission mechanism 15 include the first face gear 30, the second face gear 35, the third face gear 40 and the fourth face gear 45 as the mechanism components 16.

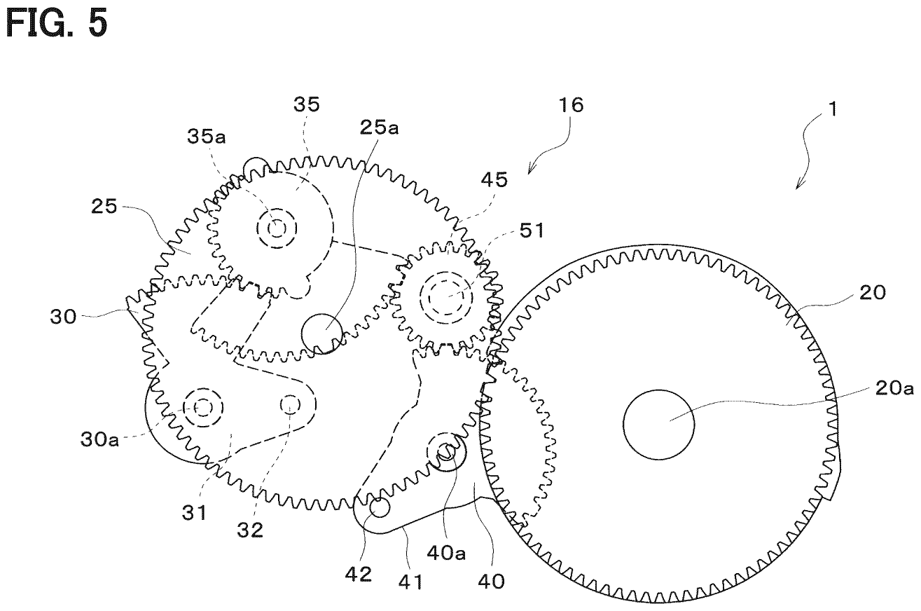

The first face gear 30 is rotatably supported by a gear shaft 30a formed at the outer surface of the air conditioning case 110 and has a lever 31 and the link pin 32. As shown in FIG. 5, the lever 31 is placed at a corresponding position of the first face gear 30, which is different from a position of the gear portion of the first face gear 30, and the lever 31 projects in a direction away from the gear shaft 30a of the first face gear 30.

The link pin 32 is formed at a distal end portion of the lever 31 at the first face gear 30. The link pin 32 extends toward the second link plate 25 and is configured to be inserted into the inside of the second link groove 26 and the inside of the third link groove 27. Thus, the drive force is transmitted from the second link plate 25 to the first face gear 30 by contacting the second link groove 26 or the third link groove 27 to the link pin 32, and thereby the first face gear 30 is rotated about the gear shaft 30a.

The second face gear 35 is configured to be rotated about a gear shaft 35a formed at the outer surface of the air conditioning case 110 and has two gear portions which are formed at two different locations, respectively. One of the two gear portions of the second face gear 35 is configured to mesh with the gear portion of the first face gear 30. Thus, the second face gear 35 is rotated about the gear shaft 35a by the drive force transmitted from the first face gear 30.

The other one of the two gear portions of the second face gear 35 is configured to mesh with the gear portion of the fourth face gear 45. Therefore, the drive force, which is transmitted to the second face gear 35, is transmitted to the fourth face gear 45.

The third face gear 40 is rotatably supported by a gear shaft 40a formed at the outer surface of the air conditioning case 110 and has a lever 41 and the link pin 42. As shown in FIG. 5, the lever 41 is placed at a corresponding position of the third face gear 40, which is different from a position of the gear portion of the third face gear 40, and the lever 41 projects in a direction away from the gear shaft 40a of the third face gear 40.

The link pin 42 is formed at a distal end portion of the lever 41 at the third face gear 40. The link pin 42 extends toward the first link plate 20 and is configured to be inserted into the inside of the first link groove 21. Thus, the drive force is transmitted from the first link plate 20 to the third face gear 40 by contacting the first link groove 21 to the link pin 42, and thereby the third face gear 40 is rotated about the gear shaft 40a.

The gear portion of the third face gear 40 is configured to mesh with the gear portion of the fourth face gear 45. Therefore, the drive force, which is transmitted to the third face gear 40, is transmitted to the fourth face gear 45.

The fourth face gear 45 is installed to the end portion of the door shaft 51 which extends through the shaft hole 110a, and the fourth face gear 45 is configured to be rotated integrally with the door shaft 51. As described above, the door shaft 51 is coupled through the shaft hole 110a to the rack and pinion placed at the inside of the air conditioning case 110, and thereby, the rotational motion of the fourth face gear 45 and the door shaft 51 is converted into the slide movement of the face door 50.

The link mechanism 1 configured in the above-described manner has two drive force transmission paths, i.e., the transmission path using the first drive force transmission mechanism 10 and the transmission path using the second drive force transmission mechanism 15 at the time of transmitting the drive force of the drive motor 5 to the face door 50.

In the case of using the first drive force transmission mechanism 10, the drive force is transmitted from the drive motor 5 through the first link plate 20, the second link plate 25, the first face gear 30, the second face gear 35, the fourth face gear 45, the door shaft 51 and the face door 50 in this order.

In contrast, in the case of using the second drive force transmission mechanism 15, the drive force is transmitted from the drive motor 5 through the first link plate 20, the third face gear 40, the fourth face gear 45, the door shaft 51 and the face door 50 in this order.

Therefore, it can be understood that the number of the mechanism components 16, which form the transmission path of the drive force, varies between the case of using the first drive force transmission mechanism 10 and the case of using the second drive force transmission mechanism 15. Specifically, in the case of using the second drive force transmission mechanism 15, the drive force is transmitted to the face door 50 through the mechanism components 16, the number of which is smaller than the number of the mechanism components 16 used in the case of using the first drive force transmission mechanism 10. Therefore, even under the influence of tolerances existing in the mechanism components 16, the operation of the slide movement of the face door 50 can be controlled with higher precision by using the second drive force transmission mechanism 15 than by using the first drive force transmission mechanism 10.

A gear ratio of the mechanism components 16 of the second drive force transmission mechanism 15 is set to be smaller than a gear ratio of the mechanism components 16 of the first drive force transmission mechanism 10. Specifically, a gear ratio of the path from the first face gear 30 to the door shaft 51 through the second face gear 35 is set to be higher than a gear ratio of the path from the third face gear 40 to the door shaft 51. Furthermore, a speed reduction ratio of the second drive force transmission mechanism 15 is set to be smaller than a speed reduction ratio of the first drive force transmission mechanism 10.

Therefore, with respect to the amount of slide movement of the face door 50 using a predetermined drive force, the amount of slide movement of the face door 50 in the case of transmitting the drive force to the face door 50 using the second drive force transmission mechanism 15 is smaller than the amount of slide movement of the face door 50 in the case of transmitting the drive force to the face door 50 using the first drive force transmission mechanism 10. Thus, in the case of transmitting the drive force through the second drive force transmission mechanism 15, fine adjustment can be made with respect to the slide movement of the face door 50, and thereby, the movement control of the face door 50 can be achieved with high stopping accuracy. In other words, in the case of transmitting the drive force by the first drive force transmission mechanism 10, with respect to the slide movement of the face door 50, the amount of movement relative to the inputted drive force can be made larger than the amount of movement relative to the inputted drive force in the case of transmitting the drive force by the second drive force transmission mechanism 15.

Hereinafter, the case of executing the large movement of the face door 50 by using the first drive force transmission mechanism 10 will be referred to as a normal drive mode. Furthermore, the case of executing the fine movement of the face door 50 by using the second drive force transmission mechanism 15 will be referred to as a high precision drive mode.

As shown in FIGS. 2 and 3, the normal drive mode and the high precision drive mode can be independently used by switching the transmission path of the drive force to one of the first drive force transmission mechanism 10 and the second drive force transmission mechanism 15 through use of the corresponding link pin and the corresponding link groove. Thereby, the appropriate moving mode of the face door 50 can be implemented by appropriately using the normal drive mode or the high precision drive mode according to the operation mode of the face door 50 which is required at the corresponding one of the various blowout modes.

Next, a state of each of the mechanism components 16 in the link mechanism 1 of the first embodiment will be explained for each of the blowout modes with reference to the drawings. First of all, an initial state of the link mechanism 1 will be described. The initial state of the link mechanism 1 refers to a state where the link pin 32 of the first face gear 30 is inserted in the second link groove 26 of the second link plate 25, and the link pin 42 of the third face gear 40 is not inserted in any of the first link groove 21 and the third link groove 27.

First of all, a state of the link mechanism 1 at the time of executing the face mode will be described with reference to FIGS. 4 to 6. In the initial state, when the drive force generated by the drive motor 5 is inputted from the first plate support shaft 20a, the first link plate 20 is rotated in a predetermined direction, and then, the drive force inputted to the first link plate 20 is transmitted to the second link plate 25 through the gear portion of the first link plate 20 and the gear portion of the second link plate 25.

The second link plate 25 is rotated about the second plate support shaft 25a by the transmitted drive force. At this time, since the link pin 32 of the first face gear 30 is inserted in the second link groove 26, the drive force of the second link plate 25 is transmitted to the first face gear 30 through the contact between the second link groove 26 and the link pin 32. Specifically, in the case of the face mode, the first drive force transmission mechanism 10 is selected as the transmission path of the drive force.

As shown in FIG. 5, the first face gear 30, the second face gear 35 and the fourth face gear 45 are arranged such that each corresponding two of the gear portions of the first face gear 30, the second face gear 35 and the fourth face gear 45 are meshed with each other. Therefore, the drive force, which is inputted to the first face gear 30, is transmitted to the face door 50 through the second face gear 35, the fourth face gear 45 and the door shaft 51. Specifically, the normal drive of the face door 50 is implemented by using the first drive force transmission mechanism 10.

At this time, the gear portion of the fourth face gear 45 is meshed with the gear portion of the third face gear 40. Thus, a portion of the drive force, which is transmitted to the fourth face gear 45, is transmitted to the third face gear 40 to rotate the third face gear 40 about the gear shaft 40a.

Furthermore, as shown in FIG. 6, the link pin 42 of the third face gear 40 is not inserted in the inside of the first link groove 21 of the first link plate 20. Therefore, the rotation of the third face gear 40 is not interfered by the first link plate 20 and is made by the drive force transmitted from the fourth face gear 45, and thereby the position of the link pin 42 is adjusted.

As described above, according to the link mechanism 1 of the first embodiment, during the face mode where the door opening degree of the face door 50 is large, the drive force of the drive motor 5 can be transmitted to the face door 50 in the normal drive mode by using the first drive force transmission mechanism 10. Thus, the slide movement of the face door 50 can be controlled with the amount of movement which corresponds to the large door opening degree.

Furthermore, since the bilevel mode is a blowout mode where the door opening degree of the face door 50 is large, the normal drive mode using the first drive force transmission mechanism 10 is used in the bilevel mode like the face mode.

The drive force of the drive motor 5 is inputted to the first link plate 20 in the state of the face mode shown in FIGS. 4 to 6 to further rotate the first link plate 20 in the predetermined direction, and thereby, a mode shift state from the face mode to the hoot mode is achieved.

Since the second link plate 25 is rotated by the drive force transmitted to the second link plate 25 at the mode shift time, the link pin 32 of the first face gear 30 is moved toward the outside of the second link groove 26 and is placed in a state where the link pin 32 is out of contact with the second link groove 26. At the same time, the first link plate 20 is also rotated by the drive force. Therefore, the link pin 42 of the third face gear 40 is moved toward the inside of the first link groove 21 of the first link plate 20. However, the link pin 42 is not yet in contact with the first link groove 21.

Thus, at the mode shift time, the drive force is used to move the first link plate 20 and the second link plate 25 and is not transmitted to the face door 50 serving as the driven member. At this time, the face door 50 does not move even in the state where the drive force is not transmitted to the face door 50 because the face door 50 is subject to: a slide resistance, which is generated between the face door 50 and the guide grooves of the air conditioning case 110; the pressure of the air flow applied to the face door 50; and the own weight of face door 50.

When the first link plate 20 and the second link plate 25 are further rotated in the predetermined direction, the link pin 32 is placed at the outside of the second link groove 26, and at the same time, the link pin 42 is placed at the inside of the first link groove 21. At this time, the link pin 42 contacts the first link groove 21 at the inside of the first link groove 21. Thereby, the drive force transmitted to the first link plate 20 is transmitted to the third face gear 40 through the first link groove 21 and the link pin 42.

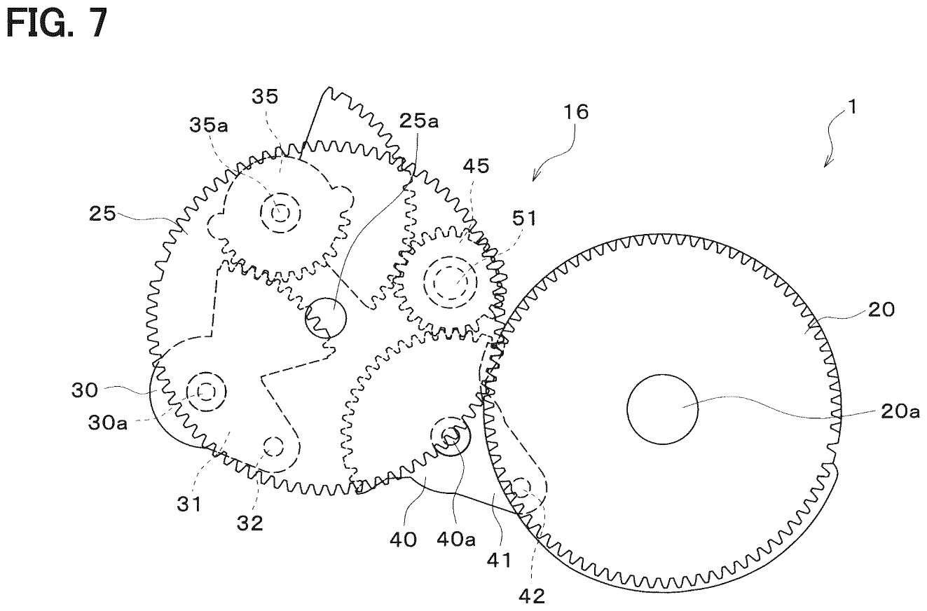

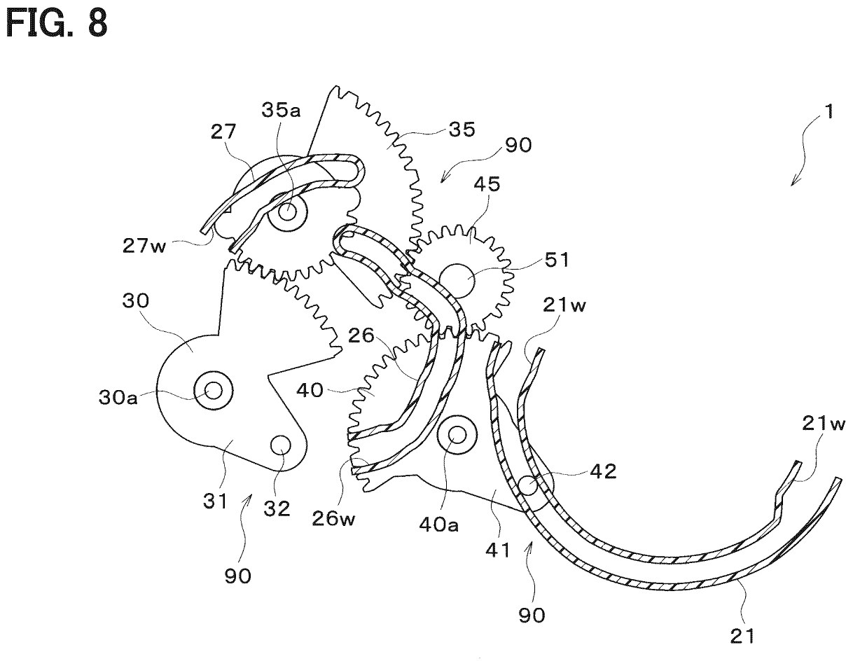

Next, a state of the link mechanism 1 at the time of executing the foot mode will be described with reference to FIGS. 7 and 8. At the time of the foot mode, the operation shifts to the high precision drive mode that uses the second drive force transmission mechanism 15. Therefore, as shown in FIG. 8, the link pin 32 is placed at the outside of the second link groove 26, and at the same time, the link pin 42 is placed at the inside of the first link groove 21.

In this case, the first link plate 20 is further rotated in the predetermined direction by the drive force inputted to the first link plate 20, and then the drive force is transmitted from the first link plate 20 to the second link plate 25 through the gear portion of the first link plate 20 and the gear portion of the second link plate 25. At this time, since the link pin 42 of the third face gear 40 contacts the first link groove 21 at the inside of the first link groove 21, the drive force is transmitted from the first link plate 20 to the third face gear 40.

Since the gear portion of the third face gear 40 and the gear portion of the fourth face gear 45 are meshed with each other, a portion of the drive force of the first link plate 20 is transmitted to the face door 50 through the third face gear 40, the fourth face gear 45 and the door shaft 51. Specifically, the high precision drive of the face door 50 is implemented by using the second drive force transmission mechanism 15.

At this time, the gear portion of the fourth face gear 45 is meshed with the gear portion of the second face gear 35. Thus, a portion of the drive force, which is transmitted to the fourth face gear 45, is transmitted to the second face gear 35 and the first face gear 30 to rotate the second face gear 35 and the first face gear 30.

Furthermore, as shown in FIG. 8, the link pin 32 of the first face gear 30 is not inserted into the second link groove 26 and the third link groove 27 of the second link plate 25 and does not contact any one of the second link groove 26 and the third link groove 27. Therefore, the rotation of the first face gear 30 and the rotation of the second face gear 35 are not interfered by the second link plate 25 and are made by the drive force transmitted from the fourth face gear 45, and thereby the position of the link pin 32 is adjusted.

As described above, according to the link mechanism 1 of the first embodiment, during the foot mode where the door opening degree of the face door 50 is small, and the fine opening degree Control is required, the drive force of the drive motor 5 can be transmitted to the face door 50 in the high precision drive mode by using the second drive force transmission mechanism 15. As a result, the fine opening control can be achieved with respect to the opening degree of the face door 50.

When the drive force of the drive motor 5 is inputted to the first link plate 20 in the state of the foot mode shown in FIGS. 7 and 8 to further rotate the first link plate 20 in the predetermined direction, a mode shift state from the foot mode to the defroster mode is achieved.

Since the first link plate 20 is rotated by the drive force transmitted to the first link plate 20 at the mode shift time, the link pin 42 of the third face gear 40 is moved toward the outside of the first link groove 21 and is placed in a state where the link pin 42 is out of contact with the first link groove 21. At the same time, the second link plate 25 is also rotated by the drive force. Therefore, the link pin 32 of the first face gear 30 is moved toward the inside of the third link groove 27 of the second link plate 25. However, the link pin 32 is not yet in contact with the third link groove 27.

Thus, at the mode shift time, the drive force is used to move the first link plate 20 and the second link plate 25 and is not transmitted to the face door 50 serving as the driven member. At this time, the face door 50 does not move even in the state where the drive force is not transmitted to the face door 50 because the face door 50 is subject to: the slide resistance, which is generated between the face door 50 and the guide grooves of the air conditioning case 110; the pressure of the air flow applied to the face door 50; and the own weight of face door 50.

When the first link plate 20 and the second link plate 25 are further rotated in the predetermined direction, the link pin 42 is placed at the outside of the first link groove 21, and at the same time, the link pin 32 is placed at the inside of the third link groove 27. At this time, the link pin 32 contacts the third link groove 27 at the inside of the third link groove 27. Thereby, the drive force transmitted to the second link plate 25 is transmitted to the first face gear 30 through the third link groove 27 and the link pin 32.

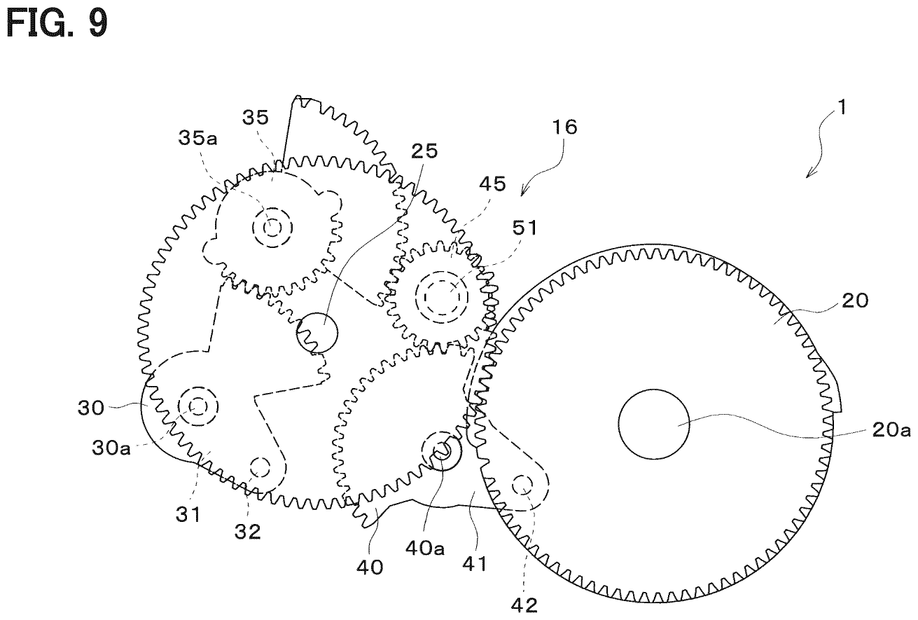

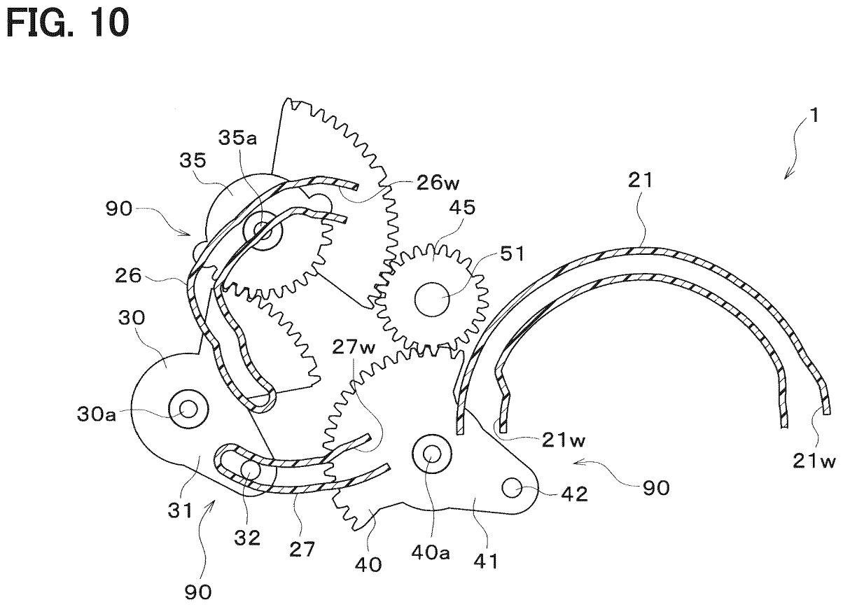

Next, a state of the link mechanism 1 at the time of executing the defroster mode will be described with reference to FIGS. 9 and 10. At the time of the defroster mode, the operation shifts to the normal drive mode that uses the first drive force transmission mechanism 10. Therefore, as shown in FIG. 10, the link pin 42 is placed at the outside of the first link groove 21, and at the same time, the link pin 32 is placed at the inside of the third link groove 27.

In this case, the first link plate 20 is further rotated in the predetermined direction by the drive force inputted to the first link plate 20, and then the drive force is transmitted from the first link plate 20 to the second link plate 25 through the gear portion of the first link plate 20 and the gear portion of the second link plate 25. At this time, the link pin 42 of the third face gear 40 is placed at the outside of the first link groove 21 of the first link plate 20 and does not contact the first link groove 21. Therefore, the drive force, which is inputted to the first link plate 20, is not transmitted to the third face gear 40.

The second link plate 25 is rotated about the second plate support shaft 25a by the drive force transmitted from the first link plate 20. At this time, since the link pin 32 of the first face gear 30 is inserted in the third link groove 27, the drive force of the second link plate 25 is transmitted to the first face gear 30 through the contact between the third link groove 27 and the link pin 42. Specifically, in the case of the defroster mode, the first drive force transmission mechanism 10 is selected as the transmission path of the drive force.

As shown in FIG. 9, the first face gear 30, the second face gear 35 and the fourth face gear 45 are arranged such that each corresponding two of the gear portions of the first face gear 30, the second face gear 35 and the fourth face gear 45 are meshed with each other. Therefore, the drive force, which is inputted to the first face gear 30, is transmitted to the face door 50 through the second face gear 35, the fourth face gear 45 and the door shaft 51. Specifically, the normal drive of the face door 50 is implemented by using the first drive force transmission mechanism 10.

At this time, the gear portion of the fourth face gear 45 is meshed with the gear portion of the third face gear 40. Thus, a portion of the drive force, which is transmitted to the fourth face gear 45, is transmitted to the third face gear 40 to rotate the third face gear 40 about the gear shaft 40a.

As described above, the link pin 42 of the third face gear 40 is not inserted in the first link groove 21 of the first link plate 20. Therefore, the rotation of the third face gear 40 is not interfered by the first link plate 20 and is made by the drive force transmitted from the fourth face gear 45, and thereby the position of the link pin 42 is adjusted.

As described above, according to the link mechanism 1 of the first embodiment, during the defroster mode where the amount of movement of the face door 50 is large, and the high door stop precision is not required, the drive force of the drive motor 5 can be transmitted to the face door 50 in the normal drive mode by using the first drive force transmission mechanism 10. As a result, the slide movement of the face door 50, which is performed with the appropriate door stop precision and corresponds to the large amount of movement, can be controlled.

Furthermore, since the foot/defroster mode is a blowout mode where the amount of movement of the face door 50 is large and does not require the high door stop precision, the normal drive mode using the first drive force transmission mechanism 10 is used in the foot/defroster mode like the defroster mode.

In the link mechanism 1, the first link groove 21 of the first link plate 20, the second link groove 26 and the third link groove 27 of the second link plate 25, the link pin 32 of the first face gear 30 and the link pin 42 of the third face gear 40 form the transmission path switch device 90.

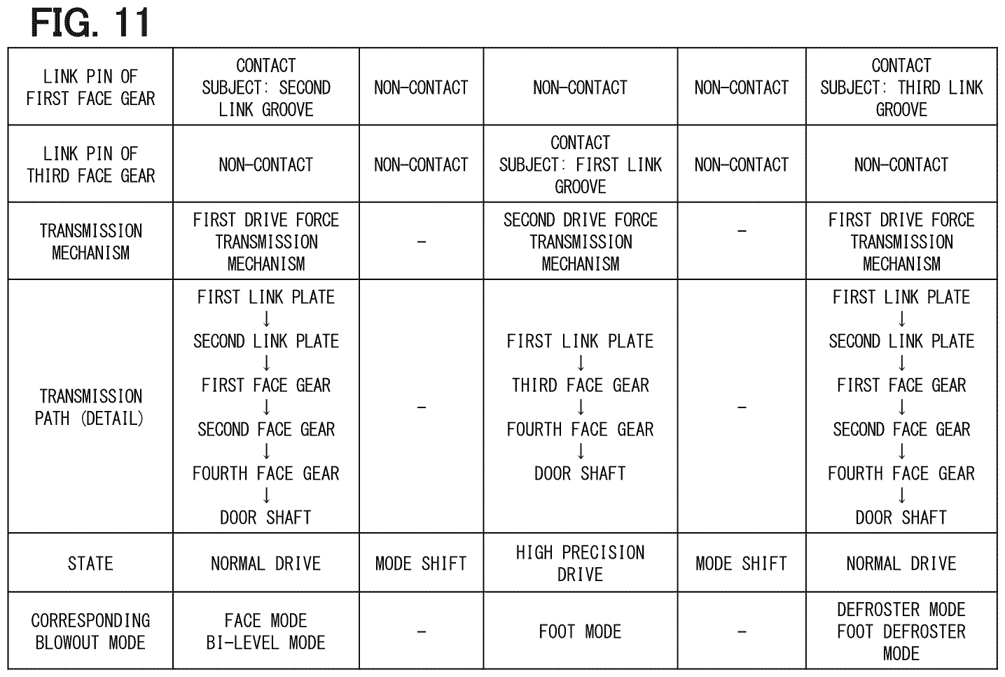

Next, a relationship between: the link mechanism 1; and the blowout mode and the drive mode, according to the first embodiment will be described with reference to FIG. 11.

As shown in FIGS. 4 to 6, in the case of the face mode or the bilevel mode, the link mechanism 1 is switched to the normal drive mode using the first drive force transmission mechanism 10. At this time, the first link groove 21 of the first link plate 20 is out of contact with the link pin 42 of the third face gear 40, and the second link groove 26 of the second link plate 25 is in contact with the link pin 32 of the first face gear 30.

Therefore, the drive force generated by the drive motor 5 is transmitted to the face door 50 through the first link plate 20, the second link plate 25, the first face gear 30, the second face gear 35, the fourth face gear 45 and the door shaft 51. Specifically, in the case of using the first drive force transmission mechanism 10, the number of the mechanism components 16 is increased in comparison to that of the second drive force transmission mechanism 15. Furthermore, the first drive force transmission mechanism 10 is configured such that the gear ratio is high, and the speed reduction ratio is high, and thereby the large slide movement of the face door 50 is possible. Thus, the appropriate movement control of the face door 50, which corresponds to the face mode or the bilevel mode, can be achieved.

As shown in FIGS. 7 and 8, in the case of the foot mode, the link mechanism 1 is switched to the high precision drive mode using the second drive force transmission mechanism 15. At this time, each of the second link groove 26 and the third link groove 27 of the second link plate 25 is out of contact with the link pin 32 of the first face gear 30, and the first link groove 21 of the first link plate 20 is in contact with the link pin 42 of the third face gear 40.

Therefore, the drive force generated by the drive motor 5 is transmitted to the face door 50 through the first link plate 20, the third face gear 40, the fourth face gear 45 and the door shaft 51. Specifically, in the case of using the second drive force transmission mechanism 15, the number of the mechanism components 16 is reduced in comparison to that of the first drive force transmission mechanism 10, and the influence of the tolerances of the respective mechanism components 16 is reduced. Furthermore, the second drive force transmission mechanism 15 is configured such that the gear ratio is low, and the speed reduction ratio is low, and thereby fine slide movement of the face door 50 is possible. Thus, the appropriate movement control of the face door 50, which corresponds to the foot mode, can be achieved.

As shown in FIGS. 9 and 10, in the case of the defroster mode or the foot/defroster mode, the link mechanism 1 is switched to the normal drive mode using the first drive force transmission mechanism 10. At this time, the first link groove 21 of the first link plate 20 is out of contact with the link pin 42 of the third face gear 40, and the third link groove 27 of the second link plate 25 is in contact with the link pin 32 of the first face gear 30.

Therefore, the drive force generated by the drive motor 5 is transmitted to the face door 50 through the first link plate 20, the second link plate 25, the first face gear 30, the second face gear 35, the fourth face gear 45 and the door shaft 51. Specifically, in the case of using the first drive force transmission mechanism 10, the number of the mechanism components 16 is increased. Furthermore, the first drive force transmission mechanism 10 is configured such that the gear ratio is high, and the speed reduction ratio is high, and thereby the large slide movement of the face door 50 is possible. Thus, the appropriate movement control of the face door 50, which corresponds to the defroster mode or the foot/defroster mode, can be achieved.

Furthermore, as shown in FIG. 11, during the mode shift time, the link pin 32 and the link pin 42 are both out of contact with: the first link groove 21 of the first link plate 20; and the second link groove 26 and the third link groove 27 of the second link plate 25. In order to complete the mode shift, the link pin 32 or the link pin 42 needs to contact one of the link grooves at the inside of the one of the link grooves.

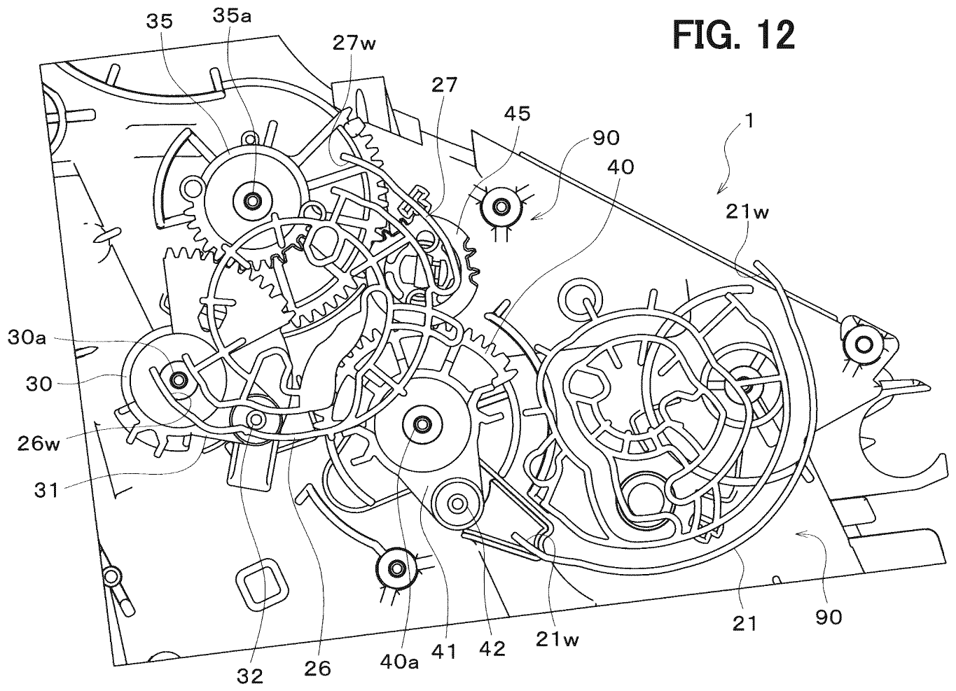

Details of the operation of the respective mechanism components 16 during the mode shift time of the link mechanism 1 of the first embodiment will be described with reference to FIGS. 12 to 15. FIGS. 12 to 15 indicate states of the respective mechanism components 16 in the case of shifting the link mechanism 1 of the first embodiment from the face mode to the foot mode.

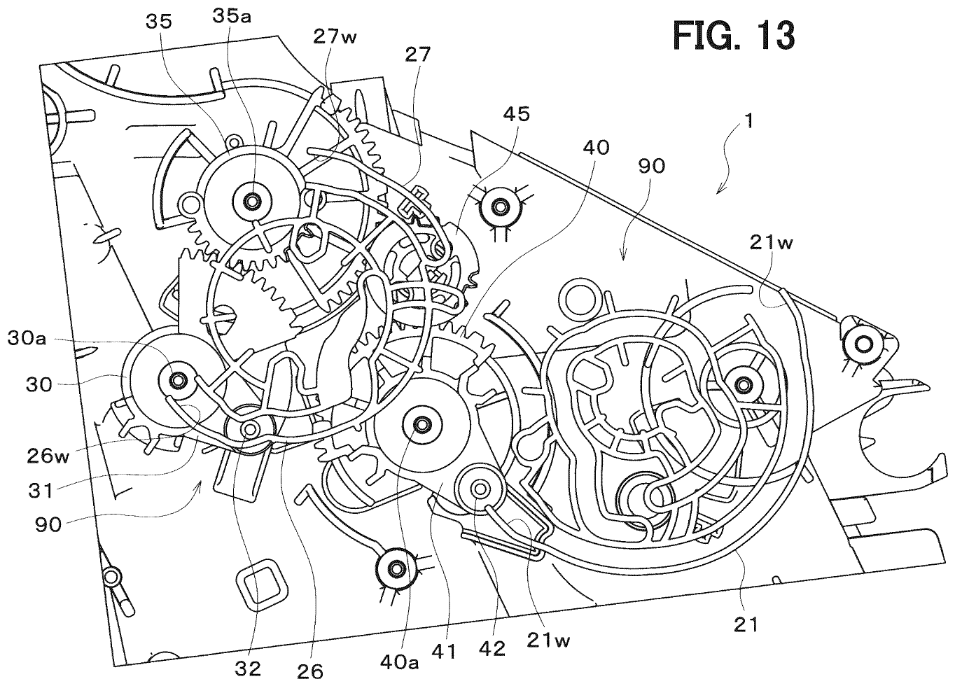

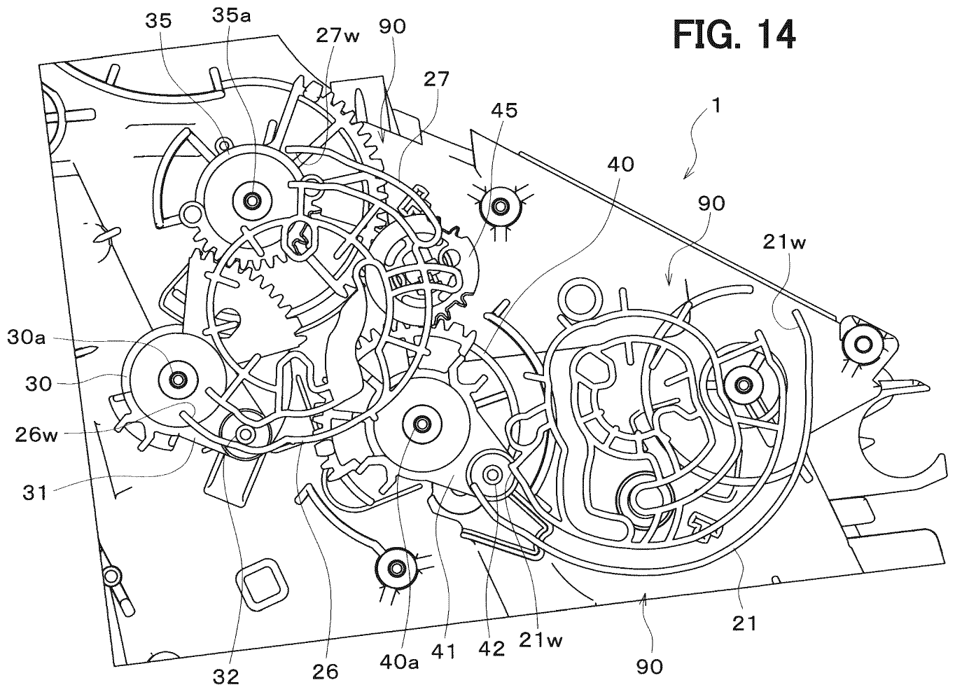

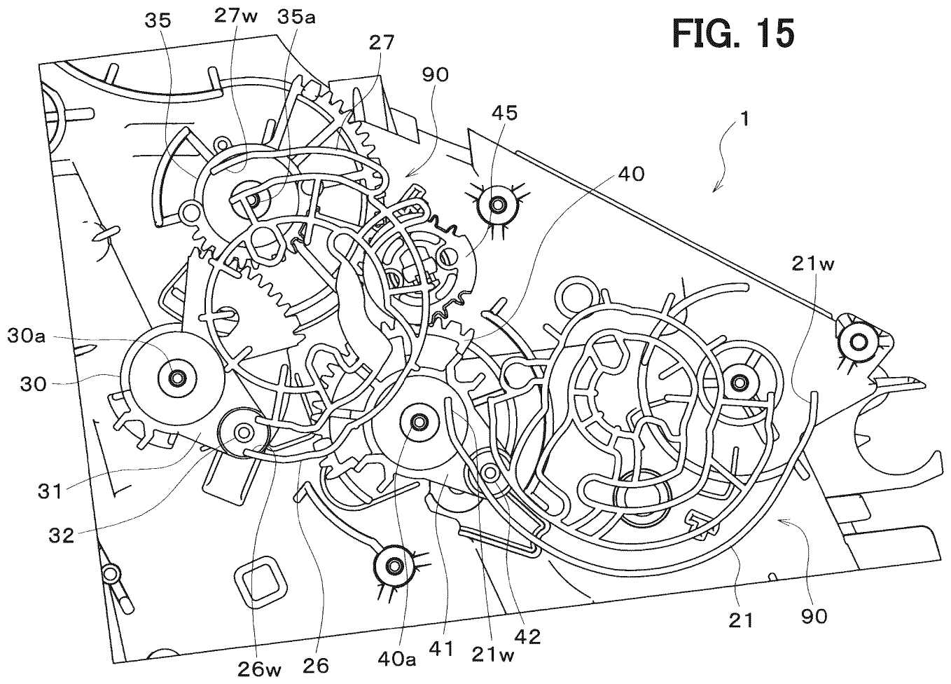

FIG. 12 shows a state of the link mechanism 1 during the face mode as a first state at the mode shift time for shifting from the face mode to the foot mode. FIG. 13 shows anther state, which is after rotating the first link plate 20 in the predetermined direction from the state shown in FIG. 12, as a second state at the mode shift time for shifting from the face mode to the foot mode. FIG. 14 shows a further state, which is after further rotating the first link plate 20 in the predetermined direction from the state shown in FIG. 13, as a third state at the mode shift time for shifting from the face mode to the foot mode. FIG. 15 shows a further state, which is shifted to the foot mode by rotating the first link plate 20 in the predetermined direction from the state shown in FIG. 14, as a fourth state at the mode shift time for shifting from the face mode to the foot mode.

As shown in FIG. 12, in the case of the face mode, the link pin 32 of the first face gear 30 contacts the second link groove 26 of the second link plate 25 at the inside of the second link groove 26. Furthermore, the link pin 42 of the third face gear 40 is placed at the outside of the first link groove 21 of the first link plate 20.

Therefore, the drive force, which is transmitted from the first link plate 20 to the second link plate 25, is transmitted to the first face gear 30 through the contact of the link pin 32 with the second link groove 26. Furthermore, the drive force, which is transmitted to the first face gear 30, is transmitted to the face door 50 through the second face gear 35, the fourth face gear 45 and the door shaft 51.

As shown in FIGS. 12 to 14, the second link plate 25 is rotated by the drive force, and the first face gear 30 is rotated about the gear shaft 30a. In response to the rotation of the second link plate 25 and the rotation of the first face gear 30, the link pin 32 is moved out of the second link groove 26.

Here, the gear portion of the third face gear 40 is meshed with the gear portion of the fourth face gear 45, and the link pin 42 is placed at the outside of the first link groove 21. The third face gear 40 is rotated about the gear shaft 40a by a portion of the drive force which is transmitted to the fourth face gear 45. Therefore, the link pin 42 of the third face gear 40 is moved into the first link groove 21 from the open end portion of the first link groove 21.

Specifically, according to the link mechanism 1, the movement of the link pin 32 and the movement of the link pin 42 can be synchronized by distributing a portion of the drive force for driving the face door 50 through the fourth face gear 45. In the case shown in FIGS. 12 to 15, the link pin 42 can be moved toward the inside of the first link groove 21 in response to moving out of the link pin 32 from the second link groove 26 by transmitting the drive force from the fourth face gear 45 to the third face gear 40.

Furthermore, as shown in FIGS. 12 to 15, each of the two opposite end portions of first link groove 21 of the first link plate 20 is opened to enable insertion of the link pin 42 therethrough and has an enlarged width portion 21w. A width of each of the enlarged width portions 21w is larger than a width of an intermediate portion of the first link groove 21 which is located between the two opposite end portions of the first link groove 21.

Furthermore, at the second link plate 25, one of two opposite end portions of the second link groove 26 and one of two opposite end portions of the third link groove 27 are opened to enable insertion of the link pin 32 therethrough and have an enlarged width portion 26w and an enlarged width portion 27w, respectively. A width of the enlarged width portion 26w is larger than a width of an intermediate portion of the second link groove 26 which is located between the two opposite end portions of the second link groove 26. A width of the enlarged width portion 27w is larger than a width of an intermediate portion of the third link groove 27 which is located between the two opposite end portions of the third link groove 27.

Since the enlarged width portion 26w is formed at the one end portion of the second link groove 26, it is possible to limit catching (holding) of the link pin 32 at the one end portion of the second link groove 26 at the time of inserting the link pin 32 into the inside of the second link groove 26. Also, since the enlarged width portion 27w is formed at the one end portion of the third link groove 27, it is possible to limit catching of the link pin 32 at the one end portion of the third link groove 27 at the time of inserting the link pin 32 into the inside of the third link groove 27. Furthermore, since the enlarged width portion 21w is formed at each of the two opposite end portions of the first link groove 21, it is possible to limit catching of the link pin 42 at each of the two opposite end portions of the first link groove 21 at the time of inserting the link pin 42 into the inside of the first link groove 21.

In other words, by forming the enlarged width portion at the open end portion of each link groove, the link mechanism 1 enables the smooth mode shift operation for shifting between the normal drive mode and the high precision drive mode, and thereby enables the reliable mode shift.

In the example shown in FIGS. 12 to 15, although there is described the operation at the mode shift time for shifting from the face mode to the foot mode, the present disclosure is not limited to this. Specifically, the effects and the actions, which are similar to the above-described ones, can be also achieved at the mode shift time for shifting from the foot mode to the defroster mode, the mode shift time for shifting from the foot mode to the face mode and the mode shift time for shifting from the defroster mode to the foot mode.

As described above, the link mechanism 1 of the first embodiment is applied to the vehicle air conditioning apparatus 100 and is used at the time of transmitting the drive force of the drive motor 5 to the face door 50 for sliding the face door 50.

According to the link mechanism 1 of the first embodiment, the transmission path switch device 90 switches the transmission path, which transmits the drive force from the drive motor 5 to the face door 50, to one of the transmission path through the first drive force transmission mechanism 10 and the transmission path through the second drive force transmission mechanism 15. The first drive force transmission mechanism 10 and the second drive force transmission mechanism 15 are configured to transmit the drive force to the face door 50 at the different speed reduction ratios, respectively. Therefore, the link mechanism 1 can realize the two different modes as the moving modes (e.g., the modes for implementing the two different amounts of movement) of the face door 50 realized by the action of the drive force. As a result, the link mechanism 1 can move the face door 50 by the appropriate amount of movement according to the scene by using the two different moving modes.

Furthermore, as shown in FIGS. 2 to 11, the number of the mechanism components 16, which form the second drive force transmission mechanism 15, is different from and is smaller than the number of the mechanism components 16, which form the first drive force transmission mechanism 10. Thereby, the amount of influence of the tolerances of the respective mechanism components 16 on the transmission of the drive force can be different between the first drive force transmission mechanism 10 and the second drive force transmission mechanism 15. Specifically, the precision with respect to the control of the movement of the face door 50 differs between the case of using the first drive force transmission mechanism 10 and the case of using the second drive force transmission mechanism 15.

As shown in FIGS. 2 to 10, the first drive force transmission mechanism 10, which has the high speed reduction ratio, includes at least two gears, such as the first face gear 30 and the second face gear 35, as the mechanism components 16. Therefore, in the case of implementing the high precision drive with the second drive force transmission mechanism 15, it is essential to use the gear such as the third face gear 40. In other words, by using the structure having the small number of the mechanism components, the high precision drive can be achieved with the first drive force transmission mechanism 10 and the second drive force transmission mechanism 15.

As shown in FIGS. 4 to 6, 9 and 10, in the face mode or the defroster mode where the amount of movement of the face door 50 is large, the link mechanism 1 operates the transmission path switch device 90 to achieve the slide movement of the face door 50 through use of the first drive force transmission mechanism 10 having the high speed reduction ratio. Furthermore, as shown in FIGS. 7 and 8, in the foot mode where the amount of movement of the face door 50 is small, the link mechanism 1 operates the transmission path switch device 90 to achieve the slide movement of the face door 50 through use of the second drive force transmission mechanism 15 having the low speed reduction ratio. Thus, the link mechanism 1 operates the transmission path switch device 90 to switch between the first drive force transmission mechanism 10 and the second drive force transmission mechanism 15 in the selected mode required by, for example, a corresponding one of the blowout modes.

In the link mechanism 1 of the first embodiment, the first drive force transmission mechanism 10 having the high speed reduction ratio includes the plurality of gears, which includes: the second link plate 25; the first face gear 30 having the lever 31 and the link pin 32; and the second face gear 35, as the mechanism components 16. Therefore, the drive force, which is transmitted to the second link plate 25, can be reliably transmitted to the face door 50.

The second drive force transmission mechanism 15 having the low speed reduction ratio includes: the first link plate 20; and the third face gear 40 having the lever 41 and the link pin 42, as the mechanism components 16. Thus, the drive force, which is transmitted to the first link plate 20, can be reliably transmitted to the face door 50, and the fine movement control of the face door 50 can be realized.

In the case of transmitting the drive force by using the first drive force transmission mechanism 10, the link pin 32 comes in contact with the second link groove 26 or the third link groove 27 of the second link plate 25 without contacting the link pin 42 to the first link groove 21 of the first link plate 20. In contrast, in the case of transmitting the drive force by using the second drive force transmission mechanism 15, the link pin 42 comes in contact with the first link groove 21 of the first link plate 20 without contacting the link pin 32 to the second link groove 26 and the third link groove 27 of the second link plate 25. Therefore, the transmission path switch device 90 of the link mechanism 1 can selectively use the first drive force transmission mechanism 10 or the second drive force transmission mechanism 15 as the transmission path of the drive force.

As shown in FIGS. 12 to 15, in the case of transmitting the drive force through the first drive force transmission mechanism 10, a portion of the drive force to be transmitted to the face door 50 can be distributed to the third face gear 40 through the fourth face gear 45. Thereby, the link pin 42 can be moved toward the first link groove 21 of the first link plate 20 as the link pin 32 moves out of the second link groove 26 or the third link groove 27 of the second link plate 25. Specifically, the transmission path switch device 90 can reliably achieve the mode shift at the link mechanism 1.

Furthermore, in the case of transmitting the drive force through the second drive force transmission mechanism 15, a portion of the drive force to be transmitted to the face door 50 can be distributed to the second face gear 35 and the first face gear 30 through the fourth face gear 45. Thereby, the link pin 32 can be moved toward one of the second link groove 26 and the third link groove 27 of the second link plate 25 as the link pin 42 moves out of the first link groove 21 of the first link plate 20. Specifically, even in this case, the transmission path switch device 90 can reliably achieve the mode shift at the link mechanism 1.

As shown in FIGS. 4 to 15, the two enlarged width portions 21w are formed at the two opposite end portions, respectively, of the first link groove 21. The enlarged width portion 26w is formed at the one end portion of the second link groove 26, and the enlarged width portion 27w is formed at the one end portion of the third link groove 27. Thus, it is possible to limit catching of the link pin at the end portion of the link groove at the time of inserting the link pin into the inside of the link groove, and thereby, it is possible to reliably achieve the mode shift.

Furthermore, the link mechanism 1 of the first embodiment is applied to the vehicle air conditioning apparatus 100 and is used to transmit the drive force to the face door 50 that is formed as the slide door for adjusting the opening cross-sectional area of the face opening 150. The appropriate opening degree of the face door 50 varies depending on the selected blowout mode at the vehicle air conditioning apparatus 100. That is, by controlling the amount of slide movement of the face door 50 through use of the link mechanism 1, it is possible to achieve the appropriate opening degree Control of the face opening 150 which corresponds to the selected blowout mode.

### Second Embodiment

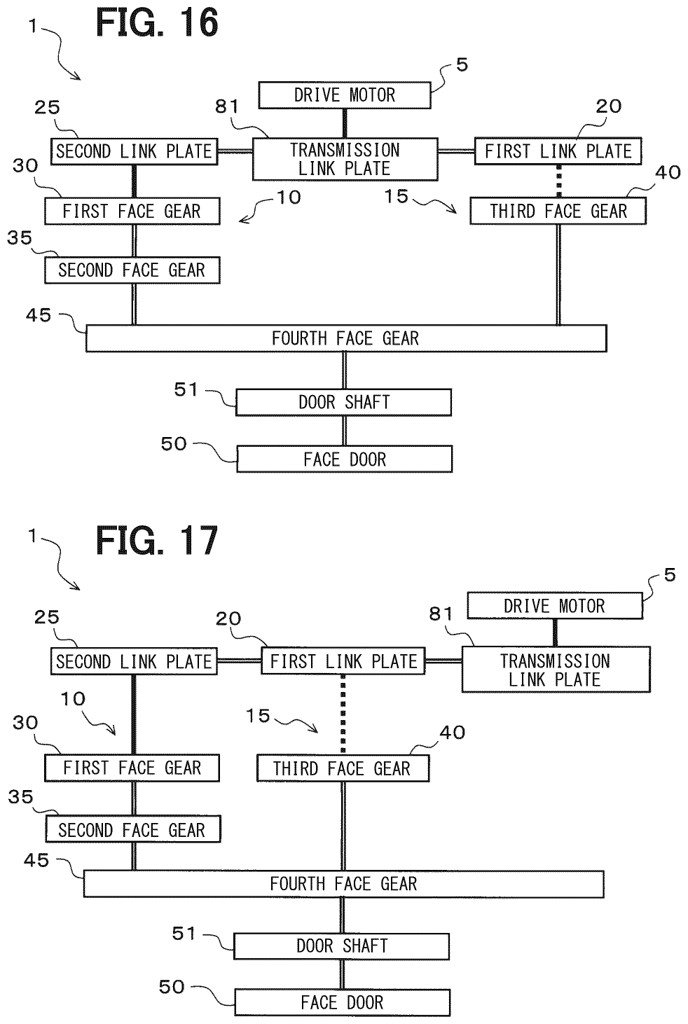

Next, a second embodiment will be described with reference to FIG. 16 in view of differences which are different from the embodiment described above. The second embodiment differs from the embodiment described above with respect to the way of transmitting the drive force of the drive motor 5 to the first link plate 20 and the second link plate 25. Since the rest of the basic structure is the same as that of the embodiment described above, description of the rest of the basic structure is omitted.

As shown in FIG. 16, in the link mechanism 1 of the second embodiment, the drive force generated by the drive motor 5 is inputted to a transmission link plate 81. The first link plate 20 of the second embodiment is installed such that the gear portion of the first link plate 20 is meshed with a gear portion of the transmission link plate 81. Furthermore, the second link plate 25 of the second embodiment is installed such that the gear portion of the second link plate 25 is meshed with the gear portion of the transmission link plate 81 at a location that is different from the location where the gear portion of the first link plate 20 is meshed with the gear portion of the transmission link plate 81.

Thus, the drive force of the drive motor 5 is transmitted to each of the first link plate 20 and the second link plate 25 through the transmission link plate 81. The transmission path of the drive force, which is transmitted to the first link plate 20 and the second link plate 25, and the operation of the transmission path switch device 90 are the same as those in the first embodiment.

As described above, according to the link mechanism 1 of the second embodiment, the same advantages as in the embodiment described above can be achieved even in the case where the transmission link plate 81 is placed between: the drive motor 5; and the first link plate 20 and the second link plate 25.

### Third Embodiment

Next, a third embodiment will be described with reference to FIG. 17 in view of differences which are different from the embodiments described above. The third embodiment differs from the first and second embodiments with respect to the way of transmitting the drive force of the drive motor 5 to the first link plate 20 and the second link plate 25. Since the rest of the basic structure is the same as that of the embodiments described above, description of the rest of the basic structure is omitted.

As shown in FIG. 17, in the link mechanism 1 of the third embodiment, the drive force of the drive motor 5 is inputted to the transmission link plate 81. The first link plate 20 of the third embodiment is installed such that the gear portion of the first link plate 20 is meshed with the gear portion of the transmission link plate 81.

Here, the second link plate 25 of the third embodiment is installed such that the gear portion of the second link plate 25 is meshed with the gear portion of the first link plate 20 like in the first embodiment. Therefore, the link mechanism 1 of the third embodiment operates in the same manner as the first embodiment, except that the drive force of the drive motor 5 is inputted to the first link plate 20 through the transmission link plate 81. For this reason, the description of the points, which are similar to those in the first embodiment, are omitted.

As described above, according to the link mechanism 1 of the third embodiment, the same advantages as in the embodiments described above can be achieved even in the case where the drive force of the drive motor 5 is transmitted to the first link plate 20 through the transmission link plate 81.

### Fourth Embodiment

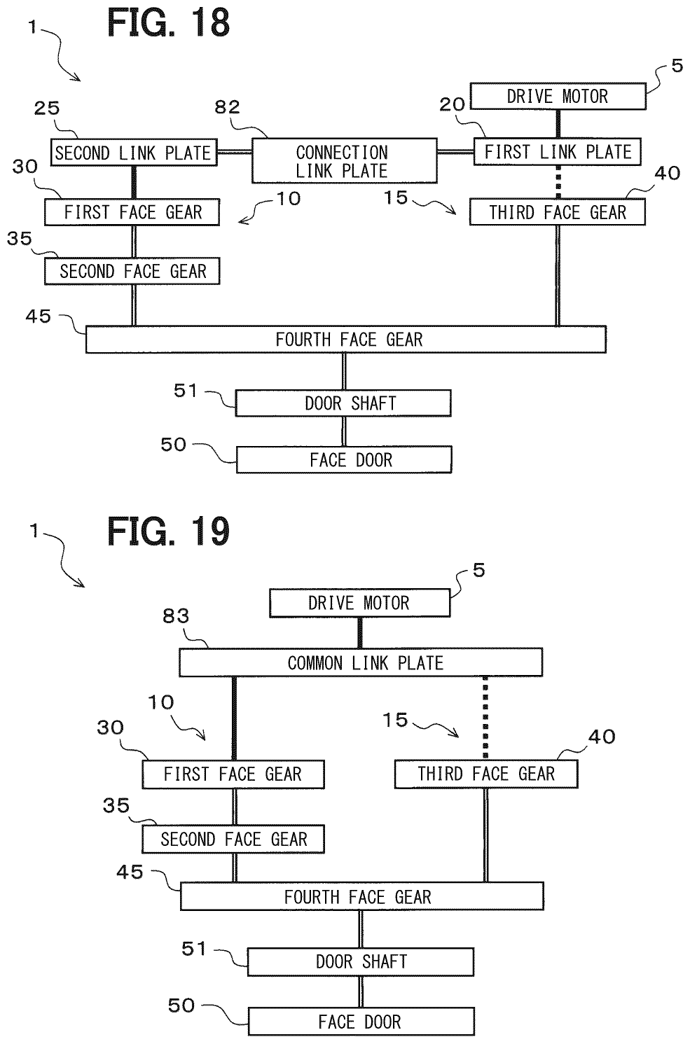

Next, a fourth embodiment will be described with reference to FIG. 18 in view of differences which are different from the embodiments described above. The fourth embodiment differs from the embodiments described above with respect to the way of transmitting the drive force from the first link plate 20 to the second link plate 25. Since the rest of the basic structure is the same as that of the embodiments described above, description of the rest of the basic structure is omitted.

As shown in FIG. 18, in the link mechanism 1 of the fourth embodiment, the drive force of the drive motor 5 is inputted to the first link plate 20 like in the first embodiment. Here, a coupling link plate 82 is placed between the first link plate 20 and the second link plate 25. A gear portion of the coupling link plate 82 is meshed with the gear portion of the first link plate 20 and the gear portion of the second link plate 25.

Thus, the drive force, which is transmitted to the first link plate 20, is transmitted to the second link plate 25 through the coupling link plate 82. Therefore, the link mechanism 1 of the fourth embodiment operates in the same manner as the embodiments described above, except that the drive force is transmitted between the first link plate 20 and the second link plate 25 through the coupling link plate 82. For this reason, the description of the points, which are similar to those in the embodiments described above, are omitted.

As described above, according to the link mechanism 1 of the fourth embodiment, the same advantages as in the embodiments described above can be achieved even in the structure where the drive force is transmitted between the first link plate 20 and the second link plate 25 through the coupling link plate 82.

### Fifth Embodiment

Next, a fifth embodiment will be described with reference to FIGS. 19 to 25 in view of differences which are different from the embodiments described above. The fifth embodiment differs from the embodiments described above with respect to use of a common link plate 83, which is common to the first drive force transmission mechanism 10 and the second drive force transmission mechanism 15, in place of the first link plate 20 and the second link plate 25. Since the rest of the basic structure is the same as that of the embodiments described above, description of the rest of the basic structure is omitted.

As shown in FIGS. 19 to 26, the link mechanism 1 of the fifth embodiment includes the first face gear 30, the second face gear 35, the third face gear 40, the fourth face gear 45, the door shaft 51 and the face door 50 like in the embodiments described above. These mechanism components 16 are the same as those described in the embodiments described above.

In the link mechanism 1 of the fifth embodiment, the common link plate 83 is placed between: the drive motor 5; and the first face gear 30 and the third face gear 40. As shown in FIG. 19, the common link plate 83 is a link plate to which the drive force of the drive motor 5 is inputted in both of the case of using the first drive force transmission mechanism 10 and the case of using the second drive force transmission mechanism 15. The common link plate 83 transmits the drive force inputted from the drive motor 5 to the first face gear 30 of the first drive force transmission mechanism 10 or the third face gear 40 of the second drive force transmission mechanism 15.

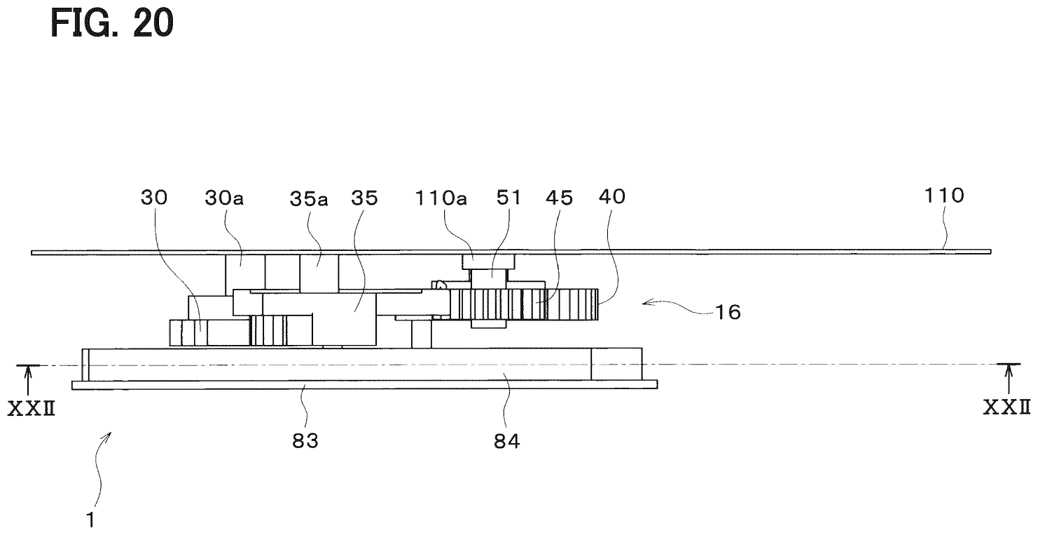

As shown in FIG. 20, the common link plate 83 is arranged to oppose the mechanism components 16 (the first to fourth face gears 30, 35, 40, 45) which are installed to the outer surface of the air conditioning case 110. The common link plate 83 is installed to a plate support shaft 83a placed at the outside of the air conditioning case 110 and is rotated by the drive force generated by the drive motor 5.

As shown in FIGS. 20 to 22, the common link plate 83 has a first link groove 84, a second link groove 85 and a third link groove 86 formed at a surface of the common link plate 83 which is opposed to the outer surface of the air conditioning case 110.

The first link groove 84 is in a form of a groove that extends along a semicircle centered on the plate support shaft 83a, and two opposite end portions of the first link groove 84 are both opened. The first link groove 84 is formed such that the link pin 42 of the third face gear 40 can be inserted into the first link groove 84. The drive force, which is transmitted to the common link plate 83, can be transmitted to the third face gear 40 through contact of the link pin 42 to the first link groove 84 at the inside of the first link groove 84.

The second link groove 85 is in a form of a groove that extends along a semicircle centered on the plate support shaft 83a, and one of two opposite end portions of the second link groove 85 is opened, and the other one of the two opposite end portions of the second link groove 85 is closed. Like the second link groove 85, the third link groove 86 is in a form of a groove that extends along a semicircle centered on the plate support shaft 83a, and one of two opposite end portions of the third link groove 86 is opened, and the other one of the opposite end portions of the third link groove 86 is closed.

The second link groove 85 and the third link groove 86 are placed closer to the plate support shaft 83a than the first link groove 84. A distance between the second link groove 85 and the plate support shaft 83a is substantially the same as a distance between the third link groove 86 and the plate support shaft 83a.

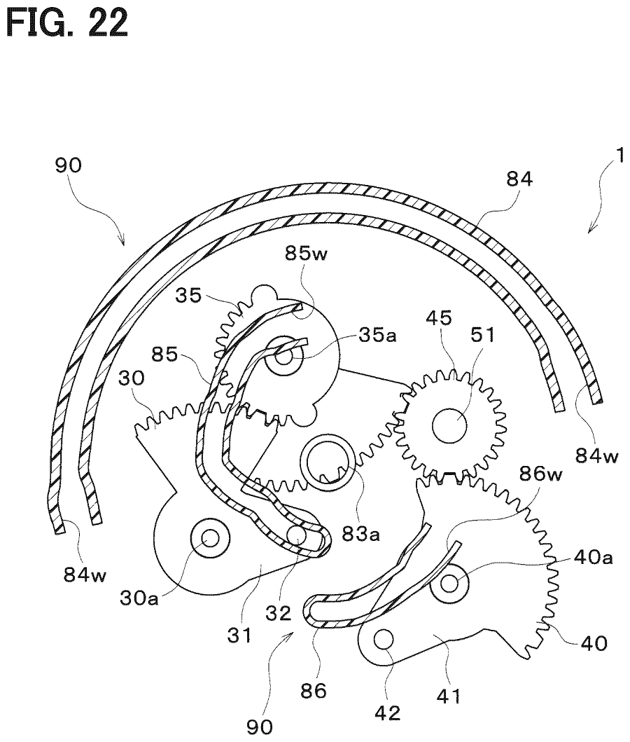

Furthermore, each of the second link groove 85 and the third link groove 86 is formed such that the link pin 32 of the first face gear 30 can be inserted into each of the second link groove 85 and the third link groove 86 through the open end portion thereof. The drive force, which is transmitted to the common link plate 83, can be transmitted to the first face gear 30 through contact of the link pin 32 to the second link groove 85 at the inside of the second link groove 85. Also, the drive force, which is transmitted to the common link plate 83, can be transmitted to the first face gear 30 through contact of the link pin 32 to the third link groove 86 at the inside of the third link groove 86. As shown in FIG. 22, the open end portion of the second link groove 85 and the open end portion of the third link groove 86 are spaced from each other by a distance and are opposed to each other. Therefore, the link pin 32, which is moved from the inside to the outside of one of the second link groove 85 and the third link groove 86, is moved a predetermined distance and is then moved into the inside of the other one of the second link groove 85 and the third link groove 86.

Therefore, even in the link mechanism 1 of the fifth embodiment, the drive force transmitted from the drive motor 5 through the common link plate 83 can be transmitted to the face door 50 through one of the first drive force transmission mechanism 10 and the second drive force transmission mechanism 15.

Furthermore, each of the two opposite end portions of the first link groove 84 is opened to enable insertion of the link pin 42 therethrough and has an enlarged width portion 84w. A width of the enlarged width portion 84w is larger than a width of an intermediate portion of the first link groove 84 which is located between the two opposite end portions of the first link groove 84. Furthermore, one of two opposite end portions of the second link groove 85 and one of two opposite end portions of the third link groove 86 are opened to enable insertion of the link pin 42 therethrough and have an enlarged width portion 85w and an enlarged width portion 86w, respectively. A width of the enlarged width portion 85w is larger than a width of an intermediate portion of the second link groove 85 which is located between the two opposite end portions of the second link groove 85. A width of the enlarged width portion 86w is larger than a width of an intermediate portion of the third link groove 86 which is located between the two opposite end portions of the third link groove 86. Therefore, even in the link mechanism 1 of the fifth embodiment, the operation at the mode shift time can be smoothly performed with the enlarged width portions 84w, 85w, 86w.

Next, the state of each of the mechanism components 16 in the link mechanism 1 of the fifth embodiment will be explained for each of the blowout modes with reference to the drawings.

First of all, a state of the link mechanism 1 at the time of executing the face mode will be described with reference to FIGS. 20 to 22. In the initial state, which is similar to that of the first embodiment, when the drive force generated by the drive motor 5 is inputted through the plate support shaft 83a, the common link plate 83 is rotated in a predetermined direction.

At this time, since the link pin 32 of the first face gear 30 is inserted in the second link groove 85, the drive force of the common link plate 83 is transmitted to the first face gear 30 through the contact between the second link groove 85 and the link pin 32. Specifically, in the case of the face mode, the first drive force transmission mechanism 10 is selected as the transmission path of the drive force.

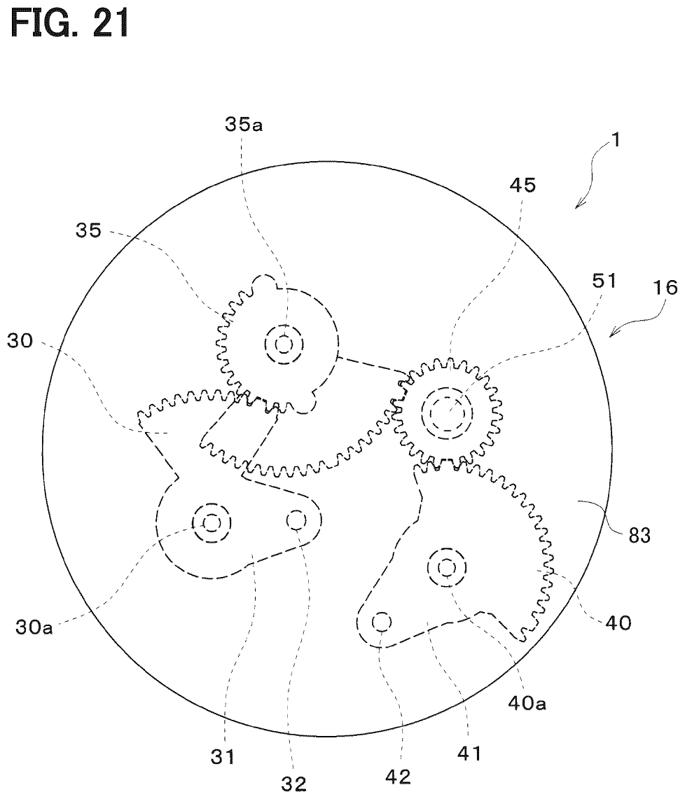

As shown in FIG. 21, the first face gear 30, the second face gear 35 and the fourth face gear 45 are arranged such that each corresponding two of the gear portions of the first face gear 30, the second face gear 35 and the fourth face gear 45 are meshed with each other. Therefore, the drive force, which is inputted to the first face gear 30, is transmitted to the face door 50 through the second face gear 35, the fourth face gear 45 and the door shaft 51. Specifically, even in the link mechanism 1 of the fifth embodiment, the normal drive of the face door 50 is implemented by using the first drive force transmission mechanism 10.

At this time, the gear portion of the fourth face gear 45 is meshed with the gear portion of the third face gear 40. Thus, a portion of the drive force, which is transmitted to the fourth face gear 45, is transmitted to the third face gear 40 to rotate the third face gear 40 about the gear shaft 40a.

Furthermore, as shown in FIG. 22, the link pin 42 of the third face gear 40 is not inserted in the inside of the first link groove 84. Therefore, the rotation of the third face gear 40 is not interfered by the contact between the first link groove 84 and the link pin 42 and is made by the drive force transmitted from the fourth face gear 45, and thereby the position of the link pin 42 is adjusted.

As described above, according to the link mechanism 1 of the fifth embodiment, during the face mode where the door opening degree of the face door 50 is large, the drive force of the drive motor 5 can be transmitted to the face door 50 in the normal drive mode by using the first drive force transmission mechanism 10. Thus, the slide movement of the face door 50 can be controlled with the amount of movement which corresponds to the large door opening degree.

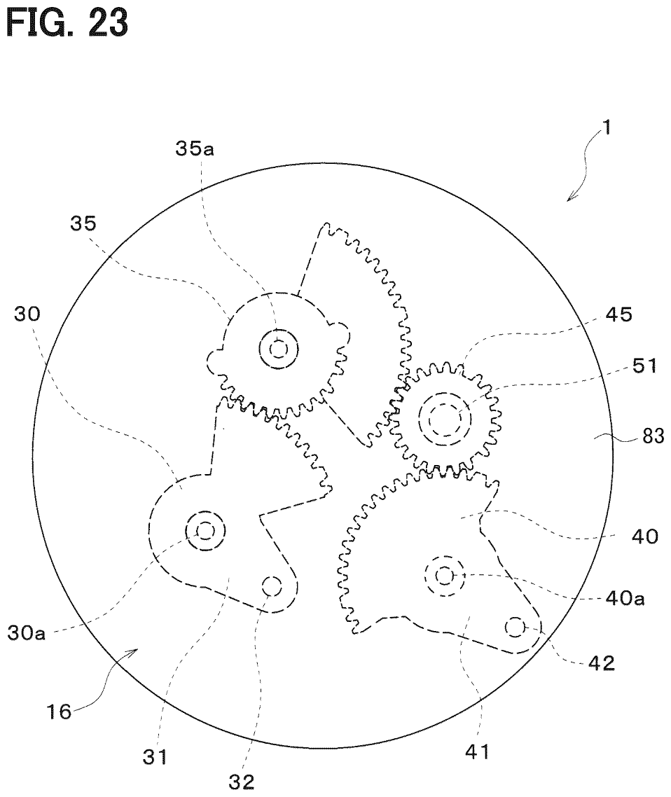

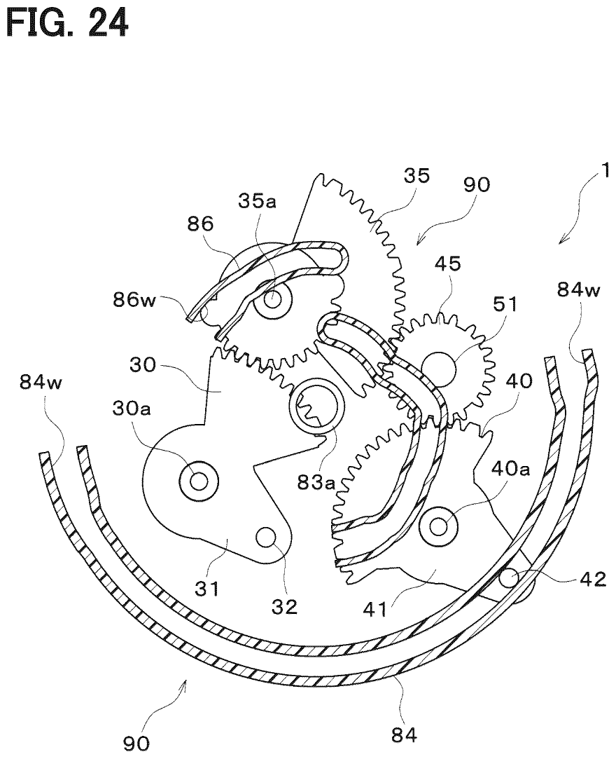

Next, a state of the link mechanism 1 at the time of executing the foot mode will be described with reference to FIGS. 23 and 24. At the time of the foot mode, the operation shifts to the high precision drive mode that uses the second drive force transmission mechanism 15. Therefore, as shown in FIG. 24, the link pin 32 is placed at the outside of the second link groove 85 and the third link groove 86, and at the same time, the link pin 42 is placed at the inside of the first link groove 84.

In this case, the common link plate 83 is further rotated in the predetermined direction by the drive force inputted to the common link plate 83. At this time, since the link pin 42 of the third face gear 40 contacts the first link groove 84 at the inside of the first link groove 84, the drive force is transmitted from the common link plate 83 to the third face gear 40.

Since the gear portion of the third face gear 40 and the gear portion of the fourth face gear 45 are meshed with each other, a portion of the drive force of the common link plate 83 is transmitted to the face door 50 through the third face gear 40, the fourth face gear 45 and the door shaft 51. Specifically, the high precision drive of the face door 50 is implemented by using the second drive force transmission mechanism 15.

At this time, the gear portion of the fourth face gear 45 is meshed with the gear portion of the second face gear 35. Thus, a portion of the drive force, which is transmitted to the fourth face gear 45, is transmitted to the second face gear 35 and the first face gear 30.

Furthermore, as shown in FIG. 24, the link pin 32 of the first face gear 30 is not inserted into the second link groove 85 and the third link groove 86 and does not contact any one of the second link groove 85 and the third link groove 86. Therefore, the rotation of the first face gear 30 and the rotation of the second face gear 35 are not interfered by the link pin 32 and the second link groove 85 and are made by the drive force transmitted from the fourth face gear 45, and thereby the position of the link pin 32 is adjusted.

As described above, according to the link mechanism 1 of the fifth embodiment, during the foot mode where the door opening degree of the face door 50 is small, and the fine opening degree Control is required, the drive force of the drive motor 5 can be transmitted to the face door 50 in the high precision drive mode by using the second drive force transmission mechanism 15. As a result, the fine opening control can be achieved with respect to the opening degree of the face door 50.

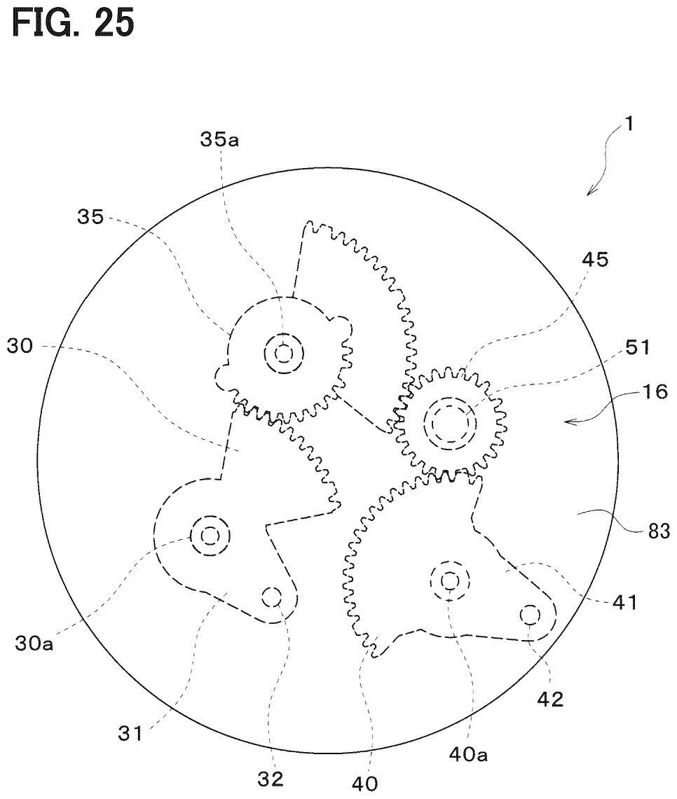

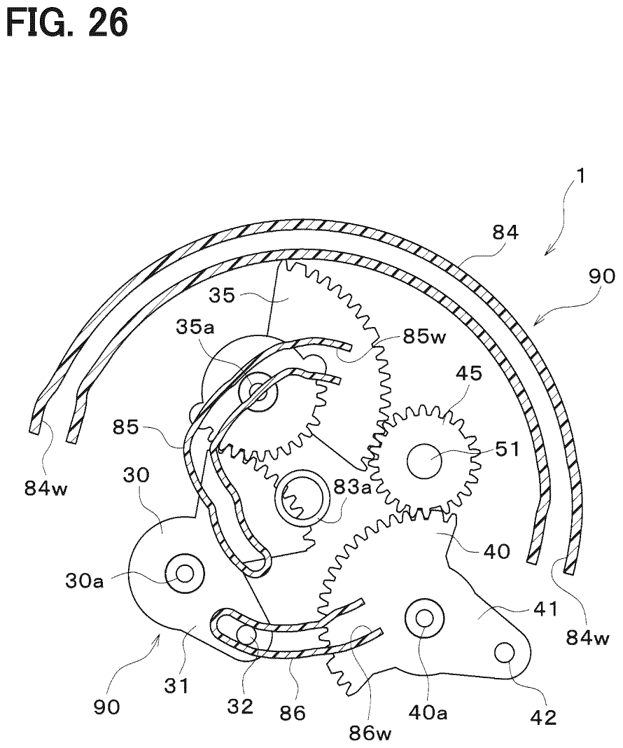

Next, a state of the link mechanism 1 at the time of executing the defroster mode will be described with reference to FIGS. 25 and 26. At the time of the defroster mode, the operation shifts to the normal drive mode that uses the first drive force transmission mechanism 10. Therefore, as shown in FIG. 26, the link pin 42 is placed at the outside of the first link groove 84, and at the same time, the link pin 32 is placed at the inside of the third link groove 86.

In this case, the common link plate 83 is further rotated in the predetermined direction by the drive force inputted to the common link plate 83. At this time, the link pin 42 of the third face gear 40 is placed at the outside of the first link groove 84 and does not contact the first link groove 84. Therefore, the drive force, which is inputted to the common link plate 83, is not transmitted to the third face gear 40.

At this time, since the link pin 32 of the first face gear 30 is inserted in the third link groove 86, the drive force of the common link plate 83 is transmitted to the first face gear 30 through the contact between the third link groove 86 and the link pin 32. Specifically, in the case of the defroster mode, the first drive force transmission mechanism 10 is selected as the transmission path of the drive force.

As shown in FIG. 25, the first face gear 30, the second face gear 35 and the fourth face gear 45 are arranged such that each corresponding two of the gear portions of the first face gear 30, the second face gear 35 and the fourth face gear 45 are meshed with each other. Therefore, the drive force, which is inputted to the first face gear 30, is transmitted to the face door 50 through the second face gear 35, the fourth face gear 45 and the door shaft 51. Specifically, the normal drive of the face door 50 is implemented by using the first drive force transmission mechanism 10.

At this time, the gear portion of the fourth face gear 45 is meshed with the gear portion of the third face gear 40. Thus, a portion of the drive force, which is transmitted to the fourth face gear 45, is transmitted to the third face gear 40 to rotate the third face gear 40 about the gear shaft 40a.

As discussed above, the link pin 42 of the third face gear 40 is not inserted in the inside of the first link groove 84. Therefore, the rotation of the third face gear 40 is not interfered by the contact between the first link groove 84 and the link pin 42 and is made by the drive force transmitted from the fourth face gear 45, and thereby the position of the link pin 42 is adjusted.

As described above, according to the link mechanism 1 of the fifth embodiment, during the defroster mode where the amount of movement of the face door 50 is large, and the high door stop precision is not required, the drive force of the drive motor 5 can be transmitted to the face door 50 in the normal drive mode by using the first drive force transmission mechanism 10. As a result, the slide movement of the face door 50, which is performed with the appropriate door stop precision and corresponds to the large amount of movement, can be controlled.

In the link mechanism 1 of the fifth embodiment, the first link groove 84, the second link groove 85 and the third link groove 86 of the common link plate 83, the link pin 32 of the first face gear 30, and the link pin 42 of the third face gear 40 form the transmission path switch device 90.

As described above, according to the link mechanism 1 of the fifth embodiment, the same advantages as in the embodiments described above can be achieved even in the case where the common link plate 83 is used in place of the first link plate 20 and the second link plate 25 of the embodiments described above.

### Sixth Embodiment

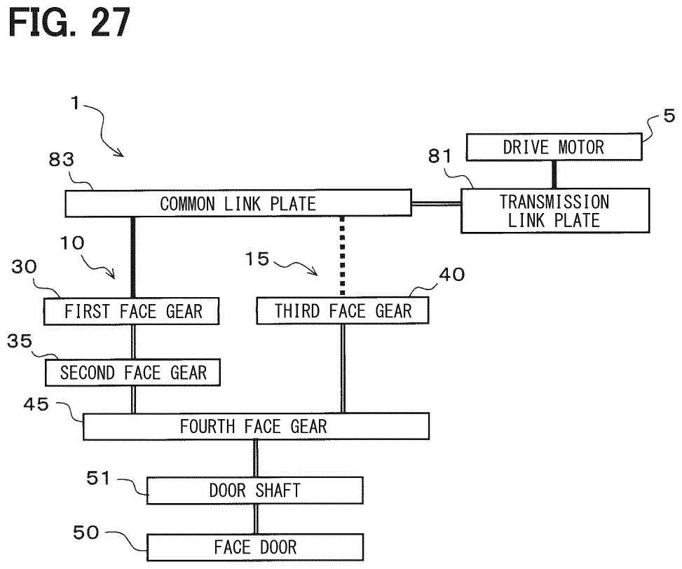

Next, a sixth embodiment will be described with reference to FIG. 27 in view of differences which are different from the embodiments described above. The sixth embodiment differs from the fifth embodiment described above with respect to the way of transmitting the drive force of the drive motor 5 to the common link plate 83. Since the rest of the basic structure is the same as that of the fifth embodiment described above, description of the rest of the basic structure is omitted.

As shown in FIG. 27, in the link mechanism 1 of the sixth embodiment, the drive force generated by the drive motor 5 is inputted to the transmission link plate 81. The common link plate 83 of the sixth embodiment is installed such that the gear portion of the common link plate 83 is meshed with the gear portion of the transmission link plate 81.

Thus, the drive force of the drive motor 5 is transmitted to the common link plate 83 through the transmission link plate 81. The transmission path of the drive force, which is transmitted to the common link plate 83, and the operation of the transmission path switch device 90 are the same as those of the fifth embodiment.

As described above, according to the link mechanism 1 of the sixth embodiment, the same advantages as in the embodiments described above can be achieved even in the case where the transmission link plate 81 is placed between the drive motor 5 and the common link plate 83.

The present disclosure is not limited to the above-described embodiments and may be modified in various ways as follows without departing from the spirit of the present disclosure.

In the embodiments described above, the link mechanism 1 is applied to the vehicle air conditioning apparatus 100. However, the present disclosure is not limited to this application. The link mechanism of the present disclosure can be applied to any of various devices as long as it is configured to move the driven member by transmitting the drive force generated by the drive device.

Furthermore, in the embodiments described above, the face door 50, which is configured to adjust the opening degree of the face opening 150 at the vehicle air conditioning apparatus 100, is used as the driven member. However, the driven member of the present disclosure is not limited to this. The driven member is not limited to the slide door, such as the face door 50, and may be any driven member as long as the driven member is moved by the drive force from the drive device (e.g., the drive motor 5).

The types of the mechanism components 16 of the first drive force transmission mechanism 10 and the second drive force transmission mechanism 15 at the link mechanism 1 are not limited to those described in the above embodiments. Any other components, which can transmit the drive force, may be used as the mechanism components 16.

Furthermore, the shapes and the locations of the first to third link grooves of the embodiments described above are mere examples and are thereby not limited to the above-described ones. The shapes and the locations of the first to third link grooves may be appropriately set according to the required movement of the driven member (e.g., the face door 50).

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one component, more, or less, are within the scope and ideology of the present disclosure.

What is claimed is:

1. A link mechanism comprising:
a drive device that is configured to generate a drive force;
a slide door that is configured to be moved by an action of the drive force generated by the drive device;
a first drive force transmission mechanism that is configured to transmit the drive force, which is generated by the drive device, to the slide door at a speed reduction ratio which is predetermined;
a second drive force transmission mechanism that is configured to transmit the drive force, which is generated by the drive device, to the slide door at a speed reduction ratio which is different from the speed reduction ratio of the first drive force transmission mechanism; and
a transmission path switch device that is configured to switch a transmission path, along which the drive force is transmitted from the drive device toward the slide door, to one of the first drive force transmission mechanism and the second drive force transmission mechanism.

2. The link mechanism according to claim 1, wherein:
each of the first drive force transmission mechanism and the second drive force transmission mechanism includes a plurality of mechanism components which are configured to transmit the drive force toward the slide door; and
a number of the plurality of mechanism components of the first drive force transmission mechanism is different from a number of the plurality of mechanism components of the second drive force transmission mechanism.

3. The link mechanism according to claim 1, wherein the plurality of mechanism components of one of the first drive force transmission mechanism and the second drive force transmission mechanism, which has the speed reduction ratio higher than the speed reduction ratio of another one of the first drive force transmission mechanism and the second drive force transmission mechanism, includes at least two gears.

4. The link mechanism according to claim 2, wherein:
the transmission path switch device is configured to use one of the first drive force transmission mechanism and the second drive force transmission mechanism, the speed reduction ratio of which is higher than the speed reduction ratio of another one of the first drive force transmission mechanism and the second drive force transmission mechanism, to transmit the drive force to the slide door in a case where an amount of movement of the slide door is larger than a predetermined amount; and
the transmission path switch device is configured to use the another one of the first drive force transmission mechanism and the second drive force transmission mechanism, the speed reduction ratio of which is lower than the speed reduction ratio of the one of the first drive force transmission mechanism and the second drive force transmission mechanism, to transmit the drive force to the slide door in a case where the amount of movement of the slide door is smaller than the predetermined amount.

5. The link mechanism according to claim 2, wherein the plurality of mechanism components of one of the first drive force transmission mechanism and the second drive force transmission mechanism, which has the speed reduction ratio higher than the speed reduction ratio of another one of the first drive force transmission mechanism and the second drive force transmission mechanism, include:
a link plate that is configured to be rotated by the drive force and has a link groove in a form of a groove, wherein at least one of two opposite end portions of the link groove is opened;
a lever that is rotatably supported and has a link pin, which is configured to be inserted in an inside of the link groove; and
a plurality of gears that are configured to be rotated and thereby transmit the drive force.

6. The link mechanism according to claim 2, wherein the plurality of mechanism components of one of the first drive force transmission mechanism and the second drive force transmission mechanism, which has the speed reduction ratio lower than the speed reduction ratio of another one of the first drive force transmission mechanism and the second drive force transmission mechanism, include:
a link plate that is configured to be rotated by the drive force and has a link groove in a form of a groove, wherein at least one of two opposite end portions of the link groove is opened; and
a lever that is rotatably supported and has a link pin, which is configured to be inserted in an inside of the link groove.

7. The link mechanism according to claim 2, wherein:
the plurality of mechanism components of each of the first drive force transmission mechanism and the second drive force transmission mechanism, include:
a link plate that is configured to be rotated by the drive force and has a link groove in a form of a groove, wherein at least one of two opposite end portions of the link groove is opened; and
a lever that is rotatably supported and has a link pin, which is configured to be inserted in an inside of the link groove;
in a case where the drive force is transmitted to the slide door through the first drive force transmission mechanism, the transmission path switch device places the link groove of the first drive force transmission mechanism in contact with the link pin of the first drive force transmission mechanism without contacting the link groove of the second drive force transmission mechanism to the link pin of the second drive force transmission mechanism; and
in a case where the drive force is transmitted to the slide door through the second drive force transmission mechanism, the transmission path switch device places the link groove of the second drive force transmission mechanism in contact with the link pin of the second drive force transmission mechanism without contacting the link groove of the first drive force transmission mechanism to the link pin of the first drive force transmission mechanism.

8. The link mechanism according to claim 7, wherein:
in the case where the drive force is transmitted to the slide door through the first drive force transmission mechanism, the transmission path switch device distributes a portion of the drive force, which is directed to the slide door, through use of at least one of the plurality of mechanism components of the second drive force transmission mechanism, and thereby
the transmission path switch device moves the link pin of the second drive force transmission mechanism toward an inside of the link groove of the second drive force transmission mechanism as the link pin of the first drive force transmission mechanism moves out of the link groove of the first drive force transmission mechanism.

9. The link mechanism according to claim 7, wherein:
in the case where the drive force is transmitted to the slide door through the second drive force transmission mechanism, the transmission path switch device distributes a portion of the drive force, which is directed to the slide door, through use of at least one of the plurality of mechanism components of the first drive force transmission mechanism, and thereby
the transmission path switch device moves the link pin of the first drive force transmission mechanism toward an inside of the link groove of the first drive force transmission mechanism as the link pin of the second drive force transmission mechanism moves out of the link groove of the second drive force transmission mechanism.

10. The link mechanism according to claim 7, wherein the at least one of the two opposite end portions of the link groove of each of the first drive force transmission mechanism and the second drive force transmission mechanism has an enlarged width portion, a width of which is larger than a width of an intermediate portion of the link groove which is located between the two opposite end portions of the link groove.

11. The link mechanism according to claim 7, comprising a transmission link plate that is placed between the drive device and at least one of the link plate of the first drive force transmission mechanism and the link plate of the second drive force transmission mechanism, wherein the transmission link plate is configured to transmit the drive force generated by the drive device to the at least one of the link plate of the first drive force transmission mechanism and the link plate of the second drive force transmission mechanism.

12. The link mechanism according to claim 7, comprising a coupling link plate that is placed between the link plate of the first drive force transmission mechanism and the link plate of the second drive force transmission mechanism, wherein the coupling link plate forms a transmission path of the drive force, which is transmitted from one of the link plate of the first drive force transmission mechanism and the link plate of the second drive force transmission mechanism to another one of the link plate of the first drive force transmission mechanism and the link plate of the second drive force transmission mechanism.

13. The link mechanism according to claim 2, wherein:
the plurality of mechanism components of each of the first drive force transmission mechanism and the second drive force transmission mechanism, include:
a lever that is rotatably supported and has a link pin;
a common link plate that is common to the first drive force transmission mechanism and the second drive force transmission mechanism and is configured to be rotated by the drive force, wherein the common link plate has:
a first link groove which is in a form of a groove, wherein at least one of two opposite end portions of the first link groove is opened, and the first link groove is configured to be inserted with the link pin of the second drive force transmission mechanism; and
a second link groove which is in a form of a groove, wherein at least one of two opposite end portions of the second link groove is opened, and the second link groove is configured to be inserted with the link pin of the first drive force transmission mechanism;
in a case where the drive force is transmitted to the slide door through the first drive force transmission mechanism, the transmission path switch device places the second link groove in contact with the link pin of the first drive force transmission mechanism without contacting the first link groove to the link pin of the second drive force transmission mechanism; and
in a case where the drive force is transmitted to the slide door through the second drive force transmission mechanism, the transmission path switch device places the first link groove in contact with the link pin of the second drive force transmission mechanism without contacting the second link groove to the link pin of the first drive force transmission mechanism.

14. The link mechanism according to claim 13, comprising a transmission link plate that is placed between the common link plate and the drive device, wherein the transmission link plate is configured to transmit the drive force generated by the drive device to the common link plate.

15. The link mechanism according to claim 1, wherein the slide door is configured to be slid by the action of the drive force along a moving path formed at an air passage, which is configured to conduct air to be supplied to an air conditioning subject space, to adjust an opening degree of the air passage.
